(19) United States
(12) Patent Application Publication
(10) Pub. No.: US 2017/0019248 A1
(43) Pub. Date: Jan. 19, 2017

(54) Homomorphic Based Method For Distributing Data From One or More Metering Devices To Two or More Third Parties

(71) Applicant: KABUSHIKI KAISHA TOSHIBA, Tokyo (JP)

(72) Inventors: Mustafa Asan MUSTAFA, Bristol (GB); Georgios KALOGRIDIS, Bristol (GB); Zhong FAN, Bristol (GB)

(21) Appl. No.: 15/124,746

(22) PCT Filed: Sep. 30, 2014
(86) PCT No.: PCT/GB2014/052956

§ 371 Date: Sep. 9, 2016

(51) Int. Cl. H04L 9/00; G06F 21/64

(52) U.S. Cl. CPC H04L 9/008; H04L 9/007; G06F 21/645; H04L 63/0428

(57) ABSTRACT

A method for validating data received by a first party from a second party, the data comprising an aggregate sum of units of data recorded by one or more metering devices, the method comprising: receiving, at the first party, the aggregate sum of units of data from the second party and an encrypted aggregate sum of the units of data from a message aggregator to which each metering device has reported its readings, the aggregate sum being encrypted using an encryption key associated with the second party, encrypting the sum of the units of the data received from the second party using the encryption key; and comparing the result of encrypting the sum of the units of data received from the second party with the encrypted aggregate sum received from the message aggregator.

### FIELD

Embodiments described herein relate to methods for distributing data from one or more metering devices to two or more third parties.

### BACKGROUND

A smart meter is an advanced meter for measuring usage of one or more utilities (typically electricity, but also e.g. gas, water, heat, telephone/internet, cable or satellite television etc) in much greater detail than a conventional meter. In future “smart homes”, it is envisaged that such meters will communicate with a number of appliances and devices within the home and communicate usage information back to utility companies for both monitoring and billing purposes. In some cases, for example where the smart meter is used to measure electrical consumption, the meters may also communicate the usage information to power grid operators. The ability for users to interact with and exchange data with power grid operators and energy suppliers using their smart meters offers significant potential for reforming the world's electricity grids and enhancing the efficiency with which the grids are operated.

Taking the example in which electricity consumption is monitored, it is anticipated that smart meters will measure their users' electricity consumption data during short time slots of e.g. 30 minutes and store accurate meter readings for each slot. Having access to such data for each time slot will enable users to be more aware of their electricity consumption and costs whilst at the same time operators will be able to manage the grid more efficiently and suppliers will be able to forecast their customers' demand more accurately. In the future, these time slots may be even shorter which raises important privacy issues regarding the availability and processing of such data; such detailed energy usage information could, for example, lay bare the daily energy usage patterns of a household and allow outside parties to deduce what kind of device or appliance was in use at any given time. It is important, therefore, to protect such sensitive data from unauthorised access.

Several solutions have been proposed for ensuring that where utility data is acquired at such short intervals, that data is prevented from being related to a specific consumer. Typically, these solutions rely on data anonymisation or data aggregation. However, such schemes assume that there is only a single recipient of the aggregated metering data of all users. In a liberalized electricity market there are many entities (e.g. grid operators, suppliers) that need to access the aggregated data of different sets of users. Here, conventional solutions for protecting the users' usage data are inefficient as they require the same metering data to be encrypted multiple times for sending to different entities, increasing computational and communication overheads for multi-recipient systems.

### BRIEF DESCRIPTION OF FIGURES

Embodiments of the invention will now be described by way of example with reference to the accompanying drawings in which:

FIG. 1 shows a schematic of entities involved in distributing utility data from one or more utility meters to a third party;

FIG. 2 shows a method of distributing utility data from one or more utility meters to a plurality of third parties in accordance with an embodiment;

FIG. 3 shows a system infrastructure for distributing utility data from one or more utility meters to a plurality of third parties in accordance with an embodiment;

FIG. 4 shows a method of distributing utility data from one or more utility meters to a plurality of third parties in accordance with an embodiment;

FIG. 5 shows a schematic of a utility meter for recording utility data in accordance with an embodiment;

FIG. 6 shows a flow diagram of steps for distributing utility data from one or more utility meters to a plurality of third parties in accordance with an embodiment;

FIG. 7 shows a flow diagram of steps performed by a utility meter when recording and reporting utility data in accordance with an embodiment;

FIG. 8 shows a schematic of operations performed by a utility meter when recording and reporting utility data in accordance with an embodiment;

FIG. 9 shows a flow diagram of steps performed by a data communication company when distributing utility data to a plurality of third parties in accordance with an embodiment;

FIG. 10 shows a schematic of operations performed by a data communication company when distributing utility data to a plurality of third parties in accordance with an embodiment;

FIG. 11 shows a flow diagram of steps performed by a distribution network operator on receipt of utility data from a data communication company in accordance with an embodiment;

FIG. 12 shows a schematic of operations performed by a distribution network operator on receipt of utility data from a data communication company in accordance with an embodiment;

FIG. 13 shows a flow diagram of steps performed by a utility service provider on receipt of utility data from a data communication company and a distribution network operator in accordance with an embodiment;

FIG. 14 shows a schematic of operations performed by a utility service provider on receipt of utility data from a data communication company and a distribution network operator in accordance with an embodiment;

FIG. 15 shows a flow diagram of steps performed by a transmission system operator on receipt of utility data from a distribution network operator in accordance with an embodiment;

FIG. 16 shows a schematic of operations performed by a transmission system operator on receipt of utility data from a distribution network operator in accordance with an embodiment;

FIG. 17 shows a flow diagram of steps carried out when changing the rate of an accounting register update in a utility meter according to an embodiment;

FIG. 18 shows a flow diagram of steps carried out during an accounting register update in a utility meter initiated by a user according to an embodiment;

FIG. 19 shows a flow diagram of steps carried out at a utility meter during an accounting register update initiated by a user according to an embodiment;

FIG. 20 shows a schematic of operations performed by a utility meter during an accounting register update according to an embodiment;

FIG. 21 shows a flow diagram of steps carried out at a utility meter during an accounting register update according to an embodiment;

FIG. 22 shows a schematic of operations performed by a utility meter during an accounting register update according to an embodiment; and

FIG. 23 shows a flow diagram of steps carried out when switching utility service providers according to an embodiment.

### DETAILED DESCRIPTION

According to a first embodiment, there is provided a method for distributing data from one or more metering devices to two or more third parties, comprising:
recording units of data at the one or more metering devices;
encrypting each unit of data to form a respective encrypted message, the encryption being carried out using an encryption key associated with a first one of the third parties;
sending the encrypted messages to a message aggregator;
aggregating, at the message aggregator, the encrypted messages to form an encrypted sum of the units of data;
sending the encrypted sum of the units of data from the message aggregator to the first one of the third parties and to a second one of the third parties;
decrypting the encrypted sum received from the message aggregator at the first one of the third parties using the encryption key to thereby obtain the sum of the units of data at the first one of the third parties;
sending the decrypted sum of the units of data from the first one of the third parties to the second one of the third parties;
encrypting, at the second one of the third parties, the sum of the units of data received from the first one of the third parties, the encryption being carried out by using the encryption key; and
comparing, at the second one of the third parties, the result of encrypting the sum of the units of data received from the first one of the third parties with the encrypted sum received from the message aggregator, so as to verify the validity of the sum of the units of data received by the second one of the third parties from the first one of the third parties.

In some embodiments, the metering devices are utility meters configured to record utility data indicating the extent of usage of a particular utility during one or more time intervals. Each unit of utility data may comprise a measure of electricity consumed during a time interval. Each unit of utility data may comprise a measure of heat consumption and/or gas consumption and/or a measure of water supplied to a site.

The encryption key may be a public homomorphic key that forms part of a homomorphic public/private key pair of the first one of the third parties. The first one of the third parties may use the homomorphic private key to decrypt the sum of the units of the data.

In some embodiments, when encrypting the units of data, the units of data are securely bound to a verification nonce in the form of a random number. On decrypting the sum of the units of data, the first one of the third parties may recover the verification nonce and send the nonce to the second one of the third parties together with the decrypted sum of the units of data.

In some embodiments, the first one of the third parties comprises a distribution network operator of an electrical power grid, the distribution network operator being configured to perform load management in a region of the power grid. In some embodiments, the second one of the third parties comprises a utility service provider, the utility service provider being a company responsible for supplying electricity to the site(s) at which the utility meters are located.

In some embodiments, the third parties include a plurality of different utility service providers. When sending an encrypted message to the message aggregator, each utility meter may also send to the message aggregator an indication of the utility service provider that is responsible for supplying electricity to the site at which the utility meter is located. The message aggregator may generate a separate encrypted sum for each utility service provider, wherein the encrypted sum that is generated for a respective utility service provider comprises an encrypted sum of the units of utility data received from utility meters that are located at sites supplied by that utility service provider. The message aggregator may send each one of the encrypted sums to the distribution network operator and further send each one of the encrypted sums to the respective utility service provider. The distribution network operator may decrypt each one of the encrypted sums received from the message aggregator and send each decrypted sum to the respective utility service provider. Each one of the utility service providers may compare the sum of the units of utility data received from the distribution network operator with the encrypted sum received from the message aggregator, so as to verify the validity of the sum of the units of utility data received from the distribution network operator.

In some embodiments, the third parties include a plurality of different distribution network operators and utility service providers, each distribution network operator being configured to perform load management in a respective region of the power grid and each distribution network operator having its own homomorphic public/private key pair. Each utility meter may carry out encryption of its utility data using the homomorphic public key belonging to the distribution network operator that is responsible for load management in the region of the grid in which the respective utility meter is located and send to the message aggregator an indication of that distribution network operator.

For each one of the distribution network operators, the message aggregator may generate a respective set of encrypted sums that is encrypted with the homomorphic public key of the respective distribution network operator. Within each set, each one of the encrypted sums may comprise an encrypted sum of the units of utility data received from utility meters that are located at sites supplied by a respective one of the utility service providers. In some embodiments, the message aggregator sends each set of encrypted sums to its respective distribution network operator and sends to each utility service provider each one of the encrypted sums that is an encrypted sum of units of utility data received from utility meters that are located at sites supplied by that respective utility service provider. Each distribution network operator may decrypt each one of the encrypted sums received from the message aggregator and send each decrypted sum to the respective utility service provider. For each decrypted sum that a utility service provider receives from a respective distribution network operator, the utility service provider may encrypt the sum with the homomorphic public key of the respective distribution network operator and compare the result with the encrypted sum received from the message aggregator, so as to verify the validity of the sum of the units of utility data received from the distribution network operator.

In some embodiments, in sending the encrypted messages from the metering devices to the message aggregator, the encrypted messages are further encrypted using an encryption key shared between the metering devices and the message aggregator.

According to a second embodiment, there is provided a method for validating data received by a first party from a second party, the data comprising an aggregate sum of units of data recorded by one or more metering devices, the method comprising:
receiving, at the first party, the aggregate sum of units of data from the second party;
receiving, at the first party, an encrypted aggregate sum of the units of data from a message aggregator to which each metering device has reported its readings, the aggregate sum being encrypted using an encryption key associated with the second party;
encrypting the sum of the units of the data received from the second party using the encryption key; and
comparing, at the first party, the result of encrypting the sum of the units of data received from the second party with the encrypted aggregate sum received from the message aggregator, so as to verify the validity of the aggregate sum of the units of data received from the second party.

In some embodiments, the first party is a utility service provider and the second party is a distribution network operator of a utility supply infrastructure, the distribution network operator being configured to manage distribution of the utility across a geographic region. The units of data may comprise utility data recorded by one or more utility meters located in said region, each unit of utility data indicating the extent of use of a utility during a time interval.

According to a third embodiment, there is provided a method for reporting utility consumption at one or more sites, the method comprising:
receiving, at a message aggregator, an encrypted message from each one of a plurality of utility meters, each message encrypting a unit of utility data that indicates the extent of use of a utility during a time interval;
receiving from each one of the plurality of utility meters, an indication of a distribution network operator that is responsible for managing distribution of the utility across a geographic region in which the utility meter is located;
receiving from each one of the plurality of utility meters, an indication of a utility service provider that is responsible for supplying the utility to the site in which the utility meter is located;
for each one of the distribution network operators:
   generating a respective set of encrypted sums, wherein within each set, each encrypted sum comprises an encrypted sum of the units of utility data received from utility meters that are located at sites supplied by a respective one of the utility service providers, the encryption being carried out using an encryption key associated with the respective distribution network operator; and
   sending each set of encrypted sums to the respective distribution network operator; and

sending to each utility service provider each one of the encrypted sums that is an encrypted sum of units of utility data received from utility meters that are located at sites supplied by that respective utility service provider.

In some embodiments, the utility is electricity and the distribution network operator is configured to perform load management in a respective region of an electrical power grid.

In any one of the above embodiments, the steps of the method may be repeated for each one of a plurality of time intervals. Each time interval may be 30 minutes or less in duration.

According to a fourth embodiment, there is provided a utility meter for monitoring usage of a utility at a site, comprising an account register for logging readings of utility usage;
the utility meter being configured to write new readings to the account register at predetermined intervals;
wherein the utility meter is configurable to alter the interval at which new readings are written to the account register;
the utility meter being configured to reply with the readings from its account register to any request sent by the user's supplier company;
wherein the utility meter is configurable to write new readings to the account register and send notification to the supplier company at a command sent by the user.

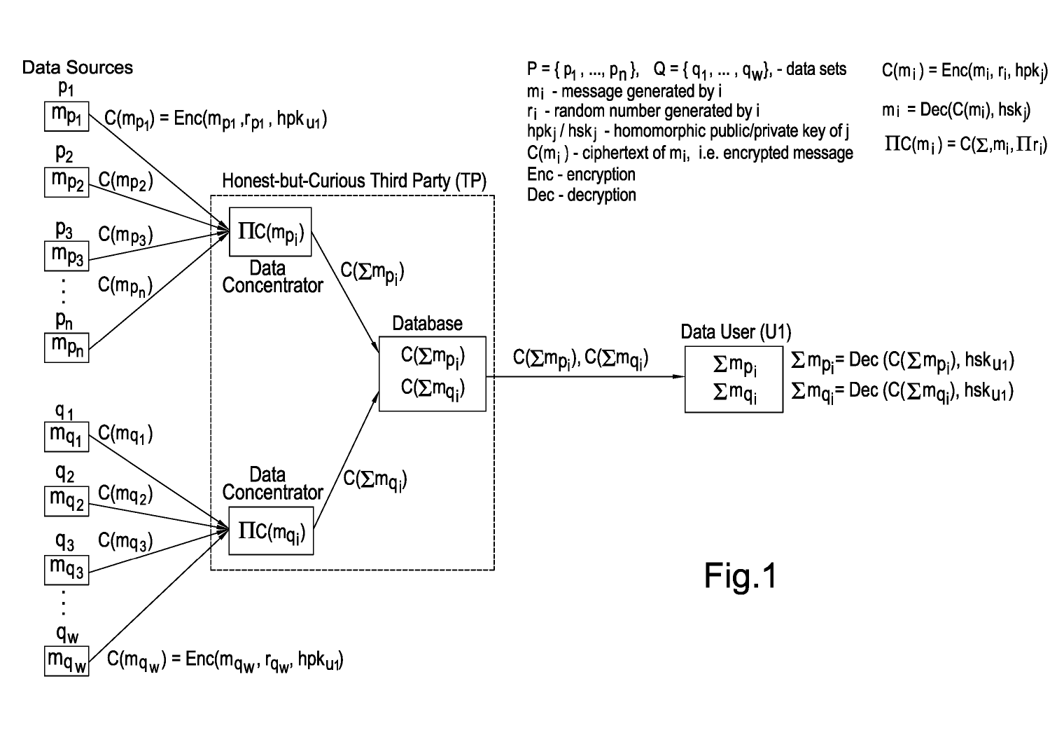

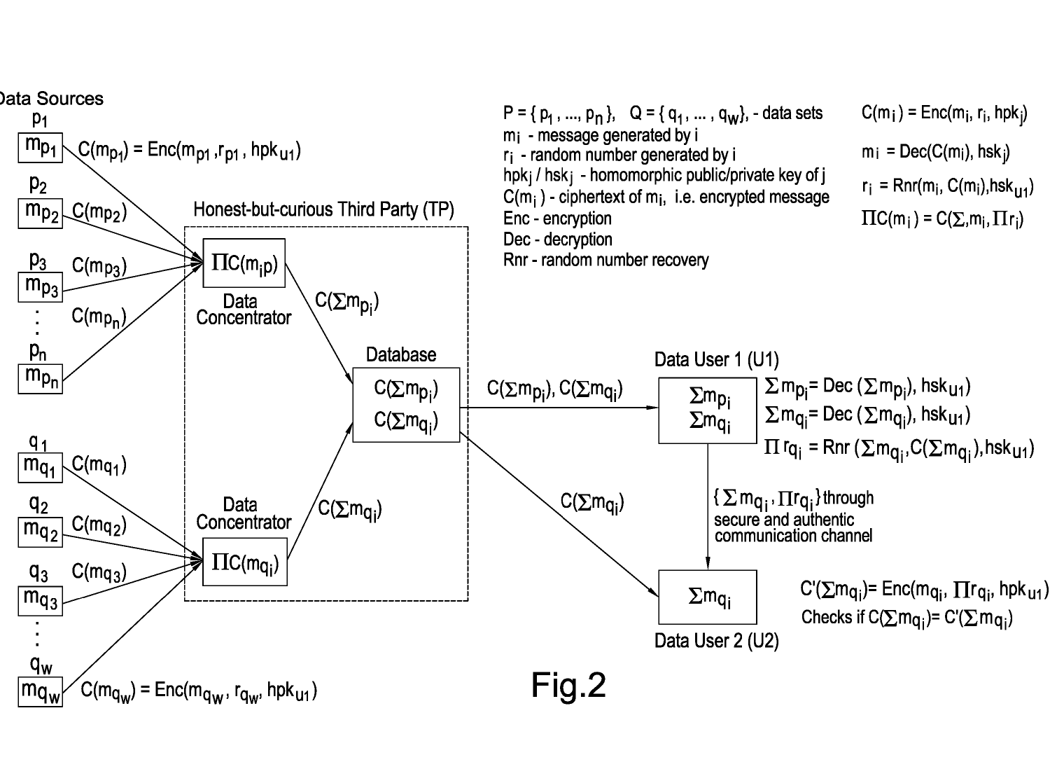

A method according to an embodiment will be described with reference FIGS. 1 and 2. FIG. 1 shows an example scenario in which there are two groups of data sources, (which can be understood to represent utility meters, for example): group P and group Q, each containing a total of n and w data nodes/generators, respectively. Each data node, e.g. pᵢ generates a numeric message, e.g. mₚᵢ that contains data indicating the usage of a particular utility. The date node does not want any outside party to gain access to the content of that individual message.

In this example, there is a single data user U1 that would like to learn the aggregate sum of the messages generated by the nodes in each group, i.e. Σmₚᵢ and Σm_{qi}. The data user U1 has an homomorphic public and private key pair, the homomorphic public and private keys being denoted as hpkᵤ₁ and hskᵤ₁, respectively.

An honest-but-curious third party (TP) is situated between the data sources and the data user U1. The TP will follow protocol specifications but it may attempt to find out the content of individual messages generated by data nodes or the sum of the messages.

In the example shown in FIG. 1, each node encrypts its message with the use of the homomorphic public key of the data user U1 to generate a ciphertext of the message, e.g. for mₚ_{₁} generated by node p₁, C(mₚ_{₁})=Enc(mₚ_{₁}, rₚ_{₁}, hpk_{U1}), where rₚ₁ is a random number used in the encryption. The node then sends the ciphertext C(mₚ_{₁}) to the TP.

The honest-but-curious TP includes one or more data concentrators that acts as a message aggregator for aggregating the encrypted messages received from the data nodes. Each data concentrator of the TP receives all the ciphertexts from the data nodes connected to it and multiplies all the received ciphertexts to generate an aggregated ciphertext. Here, use is made of the Paillier cryptosystem, which has the homomorphic property, i.e. multiplying the ciphertexts of x messages results in a ciphertext of the sum of the messages, e.g. C(m1)·C(m2)=C(m1+m2). The first data concentrator receives the ciphertexts from the nodes in group P to generate a first aggregated ciphertext for that group of nodes C(Σmₚ_{ᵢ})=πc(mₚ_{ᵢ}). The second data concentrator similarly generates an aggregated ciphertext C(Σm_{q}_{ᵢ}) for the nodes of group Q. The two aggregated ciphertexts are then sent from the respective data concentrators to the database and in turn forwarded to the data user U1.

The data user U1 receives both aggregated ciphertexts from the database and decrypts both ciphertexts using its homomorphic private key, e.g. Σmₚ_{ᵢ}=Dec(C(Σmₚ_{ᵢ}), hsk_{U1}), to obtain the sums of all the messages generated by the data nodes in each group.

By following the steps outlined above, it is possible to ensure that none of the outside parties is able to access the content of any individual message generated by a data node. The TP cannot obtain access to any of the messages or the sum of the messages as it operates only with the ciphertexts of the messages, whilst the data user U1 can obtain access to the aggregated data (i.e. the sum of the messages generated by a particular group of nodes) but not the individual messages themselves.

Let us now consider the case where there are multiple recipients (data users) U1 and U2, as shown in FIG. 2. The data user U2 would like to learn the sum of the messages generated by the nodes in group Q, i.e. Σm_{q}_{ᵢ}, but it does not trust U1 to necessarily provide a truthful report of that data. One possibility (not shown in FIG. 2) is for all the data nodes in group Q to encrypt their messages with a homomorphic public key of data user U2, e.g. each node may generate an encrypted message C(m_{q}_{₁})=Enc(m_{q}_{₁}, r_{q}_{₁}, hpk_{U2}) where r_{q1} is a random number used in the encryption and hpk_{U2} denotes the homomorphic public key of the second data user U2. The nodes will then send their ciphertexts to the TP, which will compute the aggregated ciphertext and send it to the data user U2. The data user U2 will in turn decrypt the aggregated ciphertext with the use of its homomorphic private key hsk_{U2} to obtain the sum of the messages Σm_{q}_{ᵢ}=Dec(C(Σm_{q}_{ᵢ}), hsk_{U2}).

Using the above method, data user U2 can obtain the sum of all the messages generated by the data nodes in group Q without recourse to the data user U1. However, the method is inefficient because in order for both data user U1 and data user U2 to receive the sum of messages generated by nodes in group Q, each node in group Q has to generate two ciphertexts of the same message, the first one using the homomorphic public key of U1 and the second one using the homomorphic public key of U2 (the same also applies for each node in group P). It follows that each node must also send two ciphertexts to the TP and the TP is required to perform an additional ciphertext aggregation. The computational overhead increases considerably as the number of data users increases: if there are n data users that want to learn the sum of the same number of messages, and those data users do not trust each other, each data node must generate a total of n ciphertexts of the same message (each time using the homomorphic public key of a different data user) and send the n ciphertexts to the TP. The TP must then compute n aggregated ciphertexts.

In order to address this issue of increased overhead when dealing with multiple data users/recipients, embodiments described herein implement a different set of steps from that described above.

Referring to FIG. 2, in an example embodiment, the method commences with similar steps to those described above for the case of a single recipient (see FIG. 1). That is, each data node in each group P and Q encrypts its message only once using the homomorphic public key of one of the data users, e.g. U1, and sends the ciphertext to the TP. The TP computes both aggregated ciphertexts C(Σmₚ_{ᵢ}) and C(Σm_{q}_{ᵢ}) and sends them both to the data user U1. The TP also sends the aggregated ciphertext C(Σm_{q}_{ᵢ}) of the messages from group Q to the data user U2. It will be understood that U2 cannot decrypt the aggregated ciphertext C(Σm_{q}_{ᵢ}) as it does not know the corresponding homomorphic private key (i.e. that belonging to data user U1).

The data user U1 uses its homomorphic private key to obtain the aggregated sums of the messages, Σmₚᵢ and Σm_{qi}. In accordance with the Paillier cryptosystem, given a message m, its ciphertext C(m) and the homomorphic private key hsk, the random number r embedded in C(m), which is used in the encryption of m, can be recovered.

Thus, the data user U1 is able to recover the random number Πrᵢ embedded in the aggregated ciphertext C(Σm_{qi}) using its homomorphic private key, i.e. Πr_{qi}=Rnr(Σm_{qi}, C(Σm_{qi}), hsk_{U1}). Following this, the first data user U1 sends the sum of the messages Σm_{qi} and the random number Πr_{qi} to the data user U2 through a secure and authentic communication channel. The data user U2 uses the received data items Σm_{qi} and Πr_{qi} to generate the ciphertext of the sum of the messages C′(Σm_{qi}) using the homomorphic public key of U1. By doing so, data user U2 is able to verify whether the sum of the messages Σm_{qi} received from the data user U1 is correct by checking if the computed ciphertext C′(Σm_{qi}), is the same as the ciphertext C(Σm_{qi}) that the second data user U2 has received from the TP.

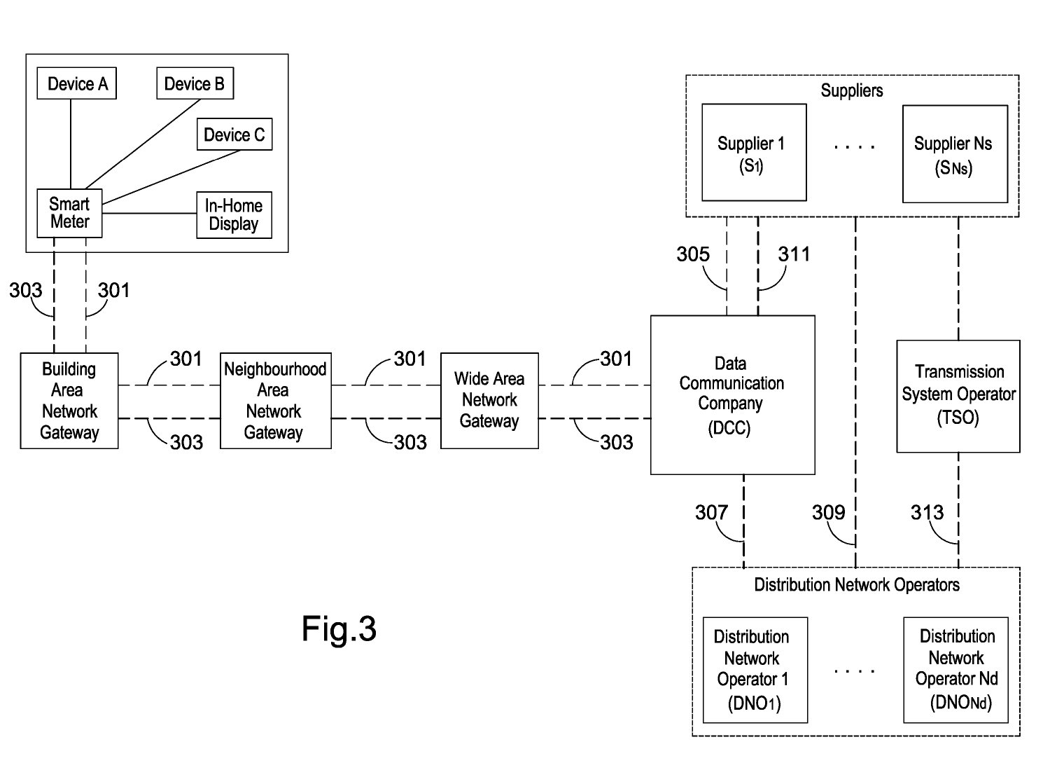

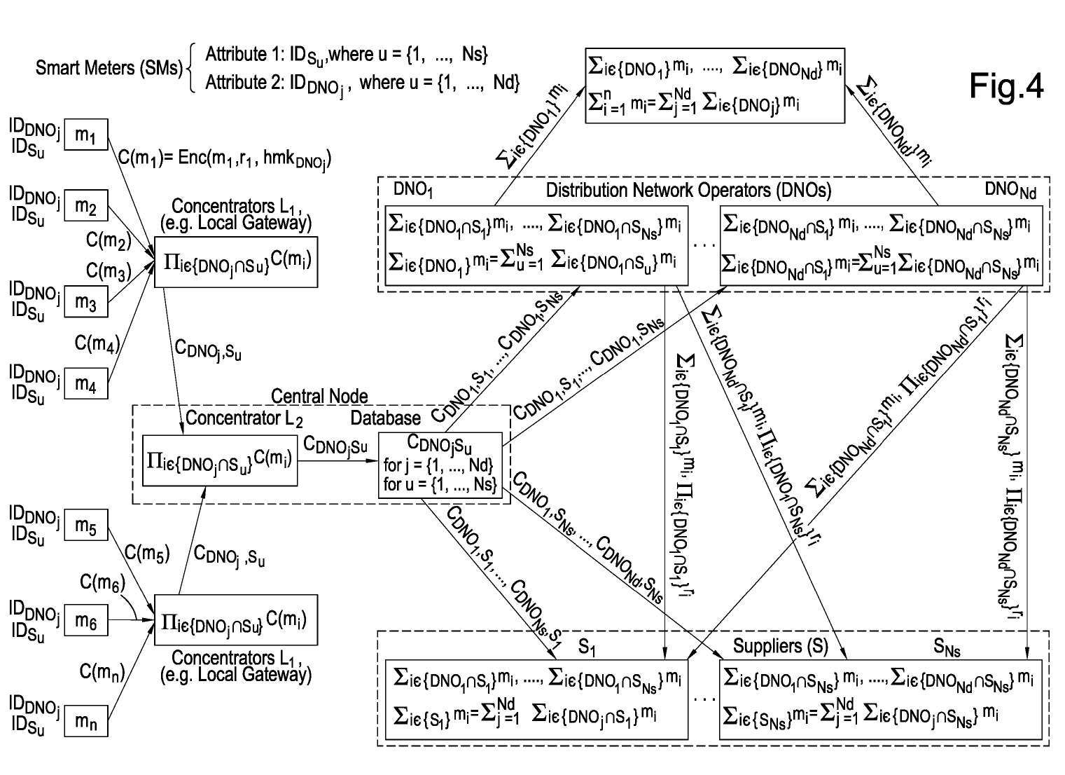

The method steps described above can be implemented in the context of a “smart metering system architecture” in which electricity is supplied across a power grid to users' homes/businesses etc. An example of such a system will be described with reference to FIGS. 3 and 4. It will be understood that, although the following description relates to consumption of electricity, embodiments described herein are equally applicable in cases where different types of utility (heat, gas, water etc) are being monitored and reported in order to manage a supply infrastructure, for example.

The following provides a list of acronyms for describing the entities of the system:
Transmission System Operator (TSO): There is one TSO that manages electricity transmission networks and it is responsible for balancing the entire grid;
Distribution Network Operator (DNO): There are Nd DNOs which cover the entire distribution networks in the grid. Each DNO manages and maintains the electricity distribution networks in its region;
Supplier (S): There are Ns suppliers each responsible for supplying electricity to its customers. The customers served by a supplier may be located in different regions across the grid;
User (U): This is a person who demands, consumes and pays its supplier for the electricity consumed;
Smart meter (SM): An advanced metering device that measures its user's electricity usage on per time slot, Tn, basis;
In-home display (IHD): A device that is linked to an SM and located inside the SM user's property. An IHD is used by its user to access, update and/or share metering data with other entities;
Data communication company (DCC): The DCC collects and communicates data between users' SMs and their suppliers and the grid operators; Networking facility: The networking facility connects users' SMs to the DCC via a hierarchical network structure consisting of building area networks (BANs), neighbourhood area networks (NANs) and wide area networks (WANs). Each BAN has a gateway (BG) that collects (and aggregates) data from a number of local SMs and forwards the data to its local NAN. Similarly, each NAN has a gateway (NG) that collects (and aggregates) data from a number of local BGs and forwards the data to its local WAN; and each WAN gateway (WG) collects (and aggregates) data from all its local NGs and forwards it to the DCC.

It will be understood that metering data used for operational purposes (e.g. power generation and distribution network control, grid balancing, etc.) need not be attributable to specific users. Aggregated data can suffice if the data can be authenticated and if it can be securely tied with a particular region (distribution network operator) and supplier. The aggregated data will be collected at high-frequency, i.e. every minute/five minutes to enable near real-time response to power quality or demand response issues within the grid.

Metering data used for billing or account management purposes does need to be attributable—i.e. securely attached to a particular user and/or account holder with a supplier. The attributable metering data need only be collected at low frequency, i.e. monthly/quarterly and on demand, e.g. change of tariff.

FIG. 3 shows the communication paths for sending the attributable (low-frequency) metering data from a respective smart meter to supplier(s) and for sending the aggregated high-frequency metering data to the suppliers, distribution network operators and transmission system operator. As can be seen, the smart meter is connected to the data communication company via two logical data transmission channels that go through local gateways. One logical data transmission channel 301 is established and used for the transmission of the (low-frequency) metering data attributable to a specific user, while the other logical channel 303 is used for the transmission of the high-frequency aggregated metering data.

The data communication company DCC is connected to each supplier through a data channel 305 through which the (low-frequency) metering data attributable to a specific user is forwarded to the corresponding supplier for invoicing, account management or any other purposes for which attributable data is required.

The data communication company DCC is moreover connected to each distribution network operator through another data channel 307. This channel is used for forwarding the high-frequency supplier-based aggregated metering data to the distribution network operator, so that each distribution network operator can use the high-frequency aggregated metering data as basis for grid load management in its region, fair calculation of distribution network usage fees for each supplier or any other operations that require such high-frequency data.

Each distribution network operator is connected to each supplier through a further data channel 309 which is used for forwarding the high-frequency region-based aggregated metering data to the supplier, so that each supplier can use such data for predicting its customers' electricity demand more accurately (to avoid paying imbalance penalties), paying the exact distribution network usage fee to each distribution network operator and any other operations that require such high-frequency data.

There are moreover further data channels 311 between the data communication company and each supplier used for forwarding the high-frequency region-based aggregated metering data to each supplier, so that each supplier can use such data to verify the correctness of the data received from each distribution network operator. There are also data channels 313 between each distribution network operator and the transmission system operator through which the high-frequency aggregated metering data of all the users in these regions are forwarded to the transmission system operator, so the transmission system operator can use these data as a basis for the entire grid and transmission lines management, balancing the grid and any other operations that require such high-frequency data.

FIG. 4 shows the architecture of a smart metering system according to an embodiment. Each entity in the system (SM, gateway, DNO, TSO, DCC and supplier) has a cryptographic public/private key pair, the public and private keys being denoted as PK and SK, respectively. Each DNO has a homomorphic public key/private key pair, the homomorphic public key and homomorphic private keys being denoted as HPK and HSK, respectively. The public key(s) PK/HPK of each entity are certified by a trusted third party (TTP) with the use of a digital certificate (CERT). Each entity's certificate contains this particular entity's identity (ID) and public key(s) PK/HPK.

Each SM is equipped with its digital certificate CERT_{SM} and private key SK_{SM} during the manufacturing process. The private key SK_{SM} is kept secret and tamper-proof. Each SM is also equipped with the digital certificates of its user's contracted supplier, the DCC, the local DNO and the local BG at the time of installation of the SM. Thus, referring to FIG. 4, each smart meter SM possesses the ID of its regional distribution network operator (ID_{DNOj}) and the ID of the supplier company contracted by the SM user (ID_{Su}).

Each gateway (concentrator) is equipped with the digital certificates of its local SMs (or gateways). The DCC has the digital certificates of all the installed SMs in the grid. Each user has an IHD device which is located on her/his premises and paired with the user's SM. The smart meters are all time synchronised.

Referring-to FIG. 4, the following requirements are set:

First, each of the DNOs and suppliers would like to learn the sums of the messages generated by the SMs that possess their attributes, i.e. Σ_{i∈{DNOj}}mᵢ and Σ_{i∈{Su}}mᵢ, respectively. In addition, each DNO would like to learn the sums of the messages generated by the SMs that are located in its region of operation and supplied by a specific supplier company, e.g. Σ_{i∈{DNOj∩S}_{₁}_{}}mᵢ, . . . , Σ_{i∈{DNOj∩S}_{_{Ns}}_{}}mᵢ.

Similarly, each supplier would like to learn the sums of the messages generated by the SMs of its customers who are located in a specific region, e.g. Σ_{i∈{DNO}_{₁}_{∩S}_{ᵤ}_{}}mᵢ, . . . , Σ_{i∈{DNO}_{_{Nd}}_{∩S}_{ᵤ}_{}}mᵢ.

The transmission system operator TSO would like to learn the sums of the messages generated by all the SMs in the whole grid, i.e. Σᵢ₌₁ⁿ mᵢ.

Importantly, the respective DNOs do not want to share any data with their competitors (other DNOs). Similarly, respective suppliers do not want to share data with their competitors (other suppliers). The respective smart meter users do not want to share the individual messages generated by their SM with any entity.

The TSO and DNOs trust each other, whilst the DNOs and suppliers do not trust each other. The central node is an honest-but-curious entity.

The above requirements can be met by implementing a method in accordance with an embodiment. Each smart meter SM encrypts its message using the homomorphic public key of its regional DNO, e.g. C(m₁)=Enc(m₁,r₁, hpk_{DNOj}). The smart meter then sends the ciphertext (attached with the SM's attributes, i.e. ID_{DNOj} and ID_{Su},) to its regional data concentrator (local gateway).

The data concentrator performs an attribute-based data aggregation, i.e. the ciphertexts attached with the same attributes are aggregated into a single aggregated ciphertext (C_{DNOj, Su}=Π_{i∈{DNOj∩Su}}C(mᵢ)). The concentrator generates Nd×Ns number of aggregated ciphertexts (again attached with the corresponding ID_{DNOj} and ID_{Su}). In some cases, the data concentrators (local gateways) may collect data only from smart meters located in one region (operated by one DNO). In such cases, the data concentrator will perform supplier-based data aggregation (aggregate only based on ID_{Su} attached to the ciphertexts) thus generating Ns number of aggregated ciphertexts.

Once the aggregation process is over, the concentrator sends the aggregated ciphertexts to the central node. The data concentrator at the central node performs an attribute-based (region-supplier-based) data aggregation, i.e. the received aggregated ciphertexts attached with the same attributes are aggregated once more into a single aggregated ciphertext (C_{DNOj, Su}=Π_{i∈{DNOj∩Su}}C(Mᵢ)). The concentrator generates Nd×Ns number of aggregated ciphertexts (again attached with the corresponding ID_{DNOj} and ID_{Su}). These ciphertexts are sent to the database of the central node.

Next, the central node perform a selective ciphertext distribution to DNOs and suppliers. Each DNO, e.g. DNOj, receives the region-supplier-based aggregated ciphertexts from all the SMs located in its region of operation, i.e. C_{DNOj, S}_{₁}, . . . , C_{DNOj, S}_{_{Ns}}. Similarly, each supplier, e.g. Su, receives the supplier-region-based aggregated ciphertexts from all the SMs of its customers, i.e. C_{DNO}_{₁}_{, S}_{ᵤ}, . . . , C_{DNO}_{_{Nd}}_{, S}_{ᵤ}.

Each DNO, e.g. DNOj then performs the following steps:

The DNO decrypts the received aggregated ciphertexts (C_{DNOj, S}_{₁}, . . . , C_{DNOj, S}_{_{Ns}}) to obtain the region-supplier-based aggregated messages, (Σ_{i∈{DNOj∩S}_{₁}_{}}mᵢ, . . . , Σ_{i∈{DNO}_{ⱼ}_{∩S}_{_{Ns}}_{}}mᵢ), using its homomorphic private key. The DNO recovers the random number embedded in each of the received aggregated ciphertexts (Π_{i∈{DNO}_{ⱼ}_{∩S}_{₁}_{}}rᵢ, . . . , Π_{i∈{DNO}_{ⱼ}_{∩S}_{_{Ns}}_{}}rᵢ). For each supplier, DNOj constructs a message containing the aggregated data and the random number extracted from the aggregated ciphertext related to the supplier (C_{DNO}_{ⱼ}_{, S}_{ᵤ}), i.e. {Σ_{i∈{DNO}_{ⱼ}_{∩S}_{ᵤ}_{}}mᵢ, Π_{i∈{DNO}_{ⱼ}_{∩S}_{ᵤ}_{}}rᵢ}, and sends the message to the supplier through secure and authenticated communication channel. The DNO sums all of the supplier-based aggregated data to get the aggregated message of all the SMs located in its region of operation, i.e. Σ_{i∈{DNO}_{ⱼ}_{}}mᵢ=Σᵤ₌₁^{Ns}Σ_{i∈{DNO}_{ⱼ}_{∩S}_{ᵤ}_{}}mᵢ, and sends the result to the transmission system operator TSO through secure and authenticated communication channel.

Each supplier performs the following steps:

The supplier receives the message sent by the central node containing the supplier-region-based aggregated ciphertexts of the messages sent from the SMs of the supplier's customers (i.e. C_{DNO}_{₁}_{,S}_{ᵤ},. . . , C_{DNO}_{_{Nd}}_{, S}_{ᵤ}). The supplier also receives the message from each DNO, e.g. DNOj, containing the aggregated data and the random number {Σ_{i∈{DNO}_{ⱼ}_{∩S}_{ᵤ}_{}}mᵢ, Π_{i∈{DNO}_{ⱼ}_{S}_{ᵤ}_{}}rᵢ}. The supplier encrypts the received aggregated message (Σ_{i∈{DNO}_{ⱼ}_{∩S}_{ᵤ}_{}}mᵢ) using the received random number (Π_{i∈{DNO}_{ⱼ}_{∩S}_{ᵤ}_{}}rᵢ) and the corresponding DNO's homomorphic public key to get a ciphertext (C′_{DNOj, S}_{ᵤ}). The supplier then verifies the correctness of the aggregated message received from each of the DNOs, e.g. DNOj by checking whether the computed ciphertext, C′_{DNOj, S}_{ᵤ}, is the same as the ciphertext received from the central node, C_{DNOj, S}_{ᵤ}. Once verified, the supplier sums all of the region-based aggregated messages to obtain the aggregated message of all the SMs of its consumers, i.e. Σ_{i∈{S}_{ᵤ}_{}}mᵢ=Σⱼ₌^{Nd}Σ_{i∈{DNO}_{ⱼ}_{∩S}_{ᵤ}_{}}mᵢ.

The transmission system operator meanwhile receives all the region-based aggregated messages sent by the DNOs and sums them to get the aggregated message of all the SMs in the grid, i.e. Σᵢ₌₁ⁿ mᵢ=Σⱼ₌₁^{Nd}Σ_{i∈{DNO}_{ⱼ}_{}}mᵢ.

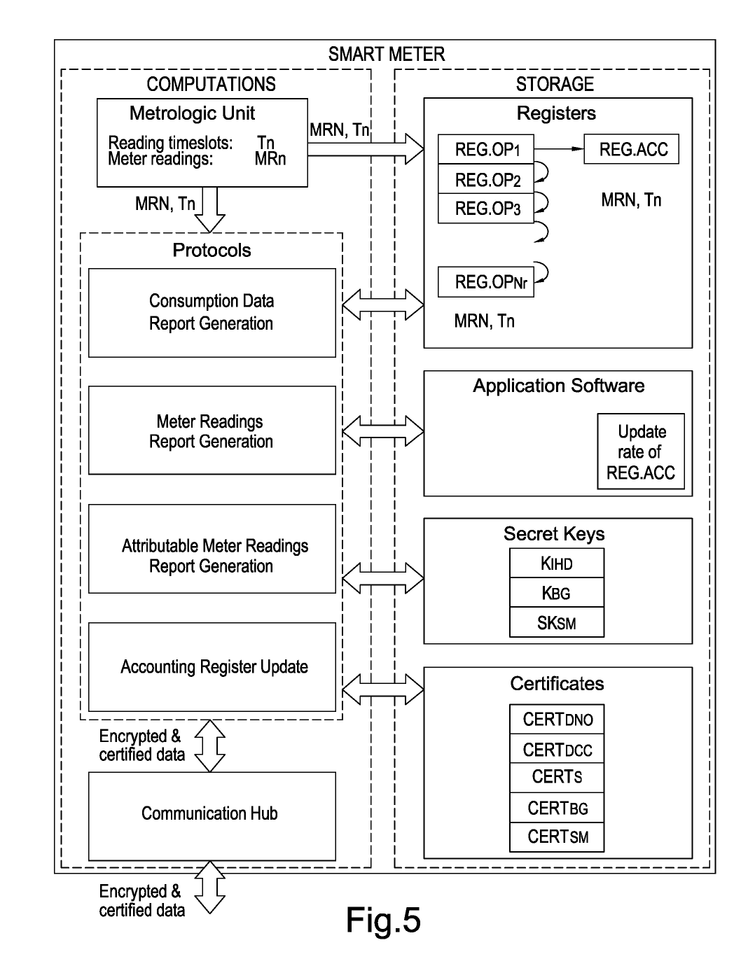

A high level description of the steps employed in the power grid according to the present embodiment will now be described with reference to FIGS. 5-16.

FIG. 5 shows a schematic of a smart meter for use in the architecture described above. As shown, the smart meter has an accounting register (REG.ACC) dedicated only for storing metering data that is used for accounting purposes, rather than just having the standard operational registers (REG.OP₁- REG.OP_{Nr}) used for storing the fine-grained metering data. The data stored on the accounting register REG.ACC will need to be attributable, tied to the owner of the smart meter or resident in the premises where the smart meter is installed.

The metrologic unit monitors the user's electricity consumption and produces meter readings MRn at reading timeslots Tn. The fine-grained meter readings and timeslots

MRn, Tn are stored on the operational registers REG.OP₁-REG.OP_{Nr} located in the storage unit of the smart meter. At each timeslot Tn, the content of the operational registers is updated, i.e. the content of the REG.OPᵢ is shifted to the REG.OPᵢ₊₁ and the freshest MRn, Tn data is stored on the first operational register REG.OP₁. In this way, the operational register REG.OP₁ always stores the most recent MRn, Tn data and the operational register REG.OP_{Nr} stores the least recent MRn, Tn data available on the smart meter.

The accounting register REG.ACC is regularly updated with meter readings and timeslots MRn, Tn from the first operational register REG.OP₁. The accounting register update rate (REG.ACC UR) is set by design to a low value (e.g. once a month) and is embedded in the application software. The meter readings MRn and timeslots Tn stored on the accounting register REG.ACC are attributable to the smart meter (user) and are used for billing and accounting purposes. This setup guaranties that the contracted supplier of the user can access fresh attributable meter readings at least once a month by default. However, if the user would like to provide the supplier with more frequent access to fresh meter readings, s/he can request an increase of the update rate of the accounting register REG.ACC when s/he signs a new contract or after it, so the update rate of the accounting register REG.ACC UR in the application software can be increased.

On the storage unit of the smart meter are also stored the secret keys of the smart meter. There are three secret keys: a symmetric key shared only between the smart meter and its in-home display device K_{IHD}, a symmetric key that is shared between the smart meter and its local building area network gateway K_{BG} and the private signature key of the smart meter SK_{SM}.

On the storage unit of the smart meter are also stored the following certificates: the certificate of the regional distribution network operator CERT_{DNO}, the certificate of the data communication CERT_{DCC}, the certificate of the user's contracted supplier CERT_{S}, the certificate of the regional building area network gateway CERT_{BG} and the certificate of the smart meter itself CERT_{SM}.

These keys and certificates are used for executing the following protocols:
Consumption data report generation; such report is used for high-frequency aggregated data reporting to grid operators and supplier.
Meter readings report generation; such report is used for high-frequency metering data reporting to user.
Attributable meter readings report generation; such report is used for (low-frequency) attributable metering data reporting to a supplier;
Accounting register update; such update releases new attributable metering data which can be read by the supplier.

Executing any of these protocols results in an encrypted and certified data (messages) which are sent to the respective recipients through the communication hub unit. No sensitive data leave the smart meter in plaintext.

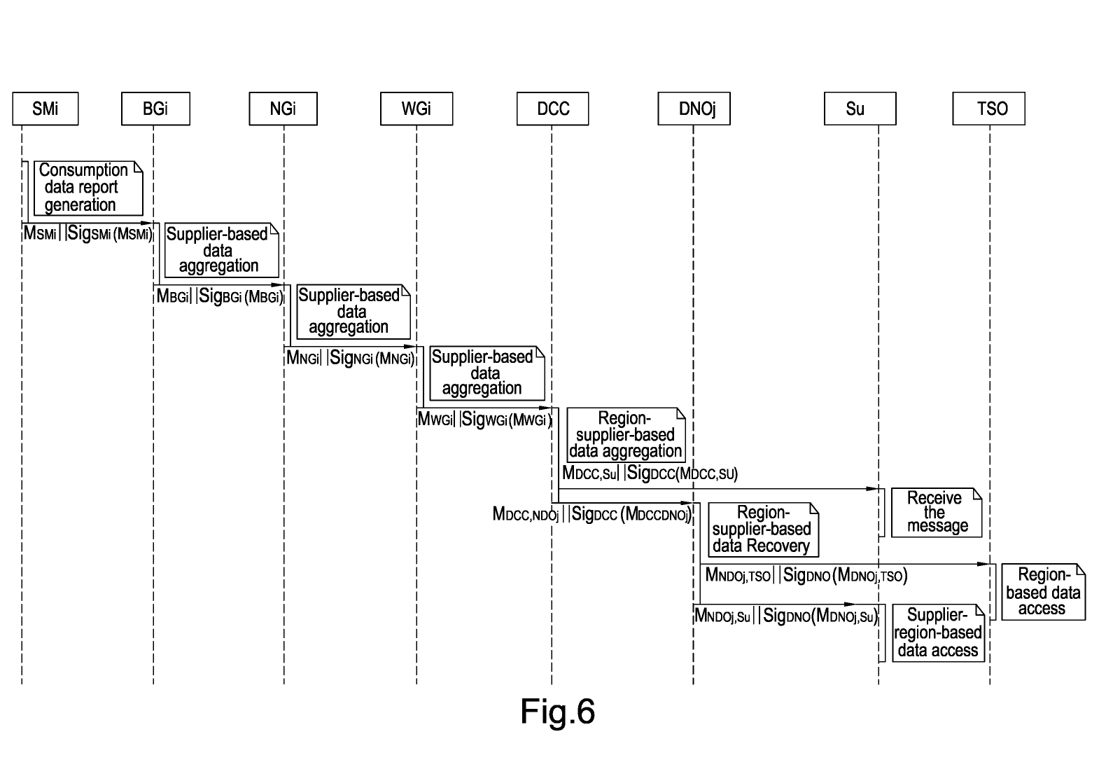

FIG. 6 depicts a flow diagram of operations performed, and messages sent between the smart meter and other entities in the smart system architecture when reporting the high-frequency aggregated metering data to grid operators and suppliers. These operations are performed at each Tn timeslot.

As shown in FIG. 6, each smart meter SMi generates an encrypted and signed consumption data report M_{SMi}∥Sig_{SMi}(M_{SMi}) and sends the report to its local building area network gateway. The report contains the following two data items: 1) the encrypted electricity consumption data of the smart meter user (generated with the use of a homomorphic encryption technique) attached with 2) the identity of the user's contracted supplier. Both of these data items can be extra protected (encrypted) using a symmetric key shared between the smart meter and its local building area network gateway.

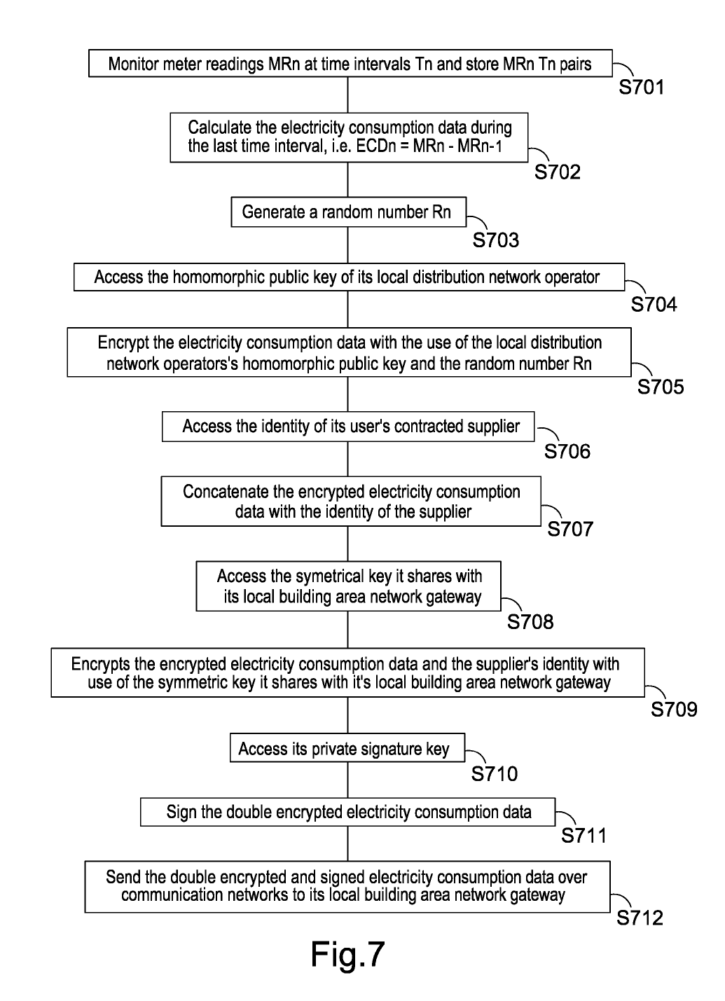

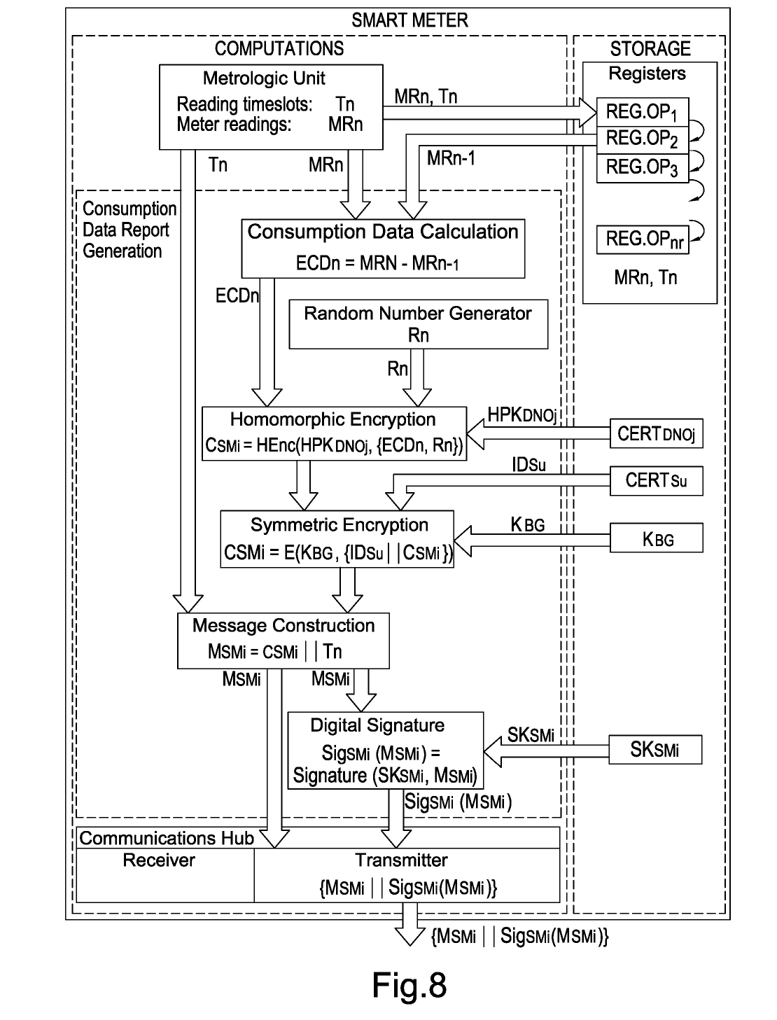

FIG. 7 shows a flow chart of the above steps of generating the encrypted and signed consumption data report at the smart meter and sending the report to the local building area network gateway. FIG. 8 shows a schematic of the above steps of generating the encrypted and signed consumption data report at the smart meter and sending the report to the local building area network gateway.

Referring to FIG. 7, in step S701, the smart meter monitors the meter readings MRn at time intervals Tn and stores the {MRn, Tn} pair on the operational registers REG.OP₁-REG.OP_{Nr}. In step S702 The smart meter accesses the meter readings at the current time interval MRn and the meter readings at the previous time interval MRn₋₁ from the operational registers to calculate the electricity consumption data of the smart meter user during the last time interval, i.e. ECDn=MRn−MRn₋₁.

In step S703, the smart meter generates a random number Rn that is required for the homomorphic encryption process. The smart meter then accesses the homomorphic public encryption key of its regional distribution network operator HPKoNo, from the operator's certificate CERT_{DNOj} (step S704). In step S705, the smart meter encrypts the electricity consumption data ECDn with the use of the local distribution network operator's homomorphic public encryption key HPK_{DNOj} and the random number Rn. The outcome of this step is an encrypted consumption data C_{SMi}. Only the owner of the corresponding homomorphic private decryption key, i.e. DNOj, can decrypt the encrypted consumption data C_{SMi}. This step is done to resist passive attacks by unauthorised entities such as the DCC, operators of other regions, suppliers and external entities.

The smart meter next accesses the identity of its user's contracted electricity supplier ID_{Su} from the supplier's certificate CERT_{Su} (step S706). The smart meter concatenates the encrypted electricity consumption data C_{SMi} with the identity of its user's contracted supplier ID_{Su}, i.e. {ID_{Su}∥C_{SMi}} (step S707). In step S708, the smart meter accesses the symmetric gateway key K_{BG}. The symmetric gateway key K_{BG} is shared between the local building area network gateway and all the smart meters connected to this gateway but it is secret to other entities and it is difficult to guess. The smart meter encrypts the encrypted electricity consumption data and its user's contracted supplier's identity {ID_{Su}∥C_{SMi}} with the use of the symmetric gateway key K_{BG} (step S709). The outcome of this step is a double encrypted electricity consumption data C_{SMi}. This step is done to resist passive attacks 1) by unauthorised entities (i.e. any eavesdropping entity that wishes to learn users' contracted supplier); and 2) by authorised entities (i.e. an eavesdropping regional distribution network operator that wishes to learn individual users' fine grained consumption data). Note that this step provides an extra protection of the users' consumption data and an additional user privacy protection by hiding the users' contracted suppliers from any eavesdropping entities.

In step S710, the smart meter accesses its private signature key SK_{SMi}. This key SK_{SMi} is only known by the smart meter and it is not shared with other entities. The smart meter generates a signature on the double encrypted consumption data with the use of its private signature key SK_{SMi} (step S711). This step is done to resist active attacks by any entities. Finally, in step S712, the smart meter sends the double encrypted and signed electricity consumption data over communication networks to its local building area network gateway.

Returning back to FIG. 6, each building area network gateway BGi receives the encrypted and signed reports from all its connected (child) smart meters, verifies the reports' authenticity and performs a supplier-based data aggregation. In other words, the encrypted electricity consumption data attached with the same supplier identity are aggregated into a single aggregated ciphertext which is then also attached with the same supplier identity (the aggregation is done by multiplying the individual ciphertexts). In the end, the building area network gateway generates Ns aggregated ciphertexts, each attached with the identity of the corresponding supplier, concatenates these aggregated ciphertexts to construct a single message M_{BGi}, generates a signature on the message Sig_{BGi}(M_{BGi}) and sends both items M_{BGi}∥Sig_{BGi}(M_{BGi}) to its local neighbourhood area network gateway. The message MBG1 can also be extra protected (encrypted) using a symmetric key shared between the building area network gateway and its local neighbourhood area network gateway.

Each neighbourhood/wide area gateway, e.g. NGi/WGi, performs similar operations as the building area network gateway except that it receives messages from its local building/neighbourhood area network gateways and sends its encrypted and signed message to its local WG/the DCC.

Note that these supplier-based aggregation operations performed at the gateways are used for reducing the communication overhead between the smart meters and the data communication company DCC. In some cases, the gateways may receive the encrypted electricity consumption data from smart meters and forward the data to the data communication company DCC without performing any aggregation processes.

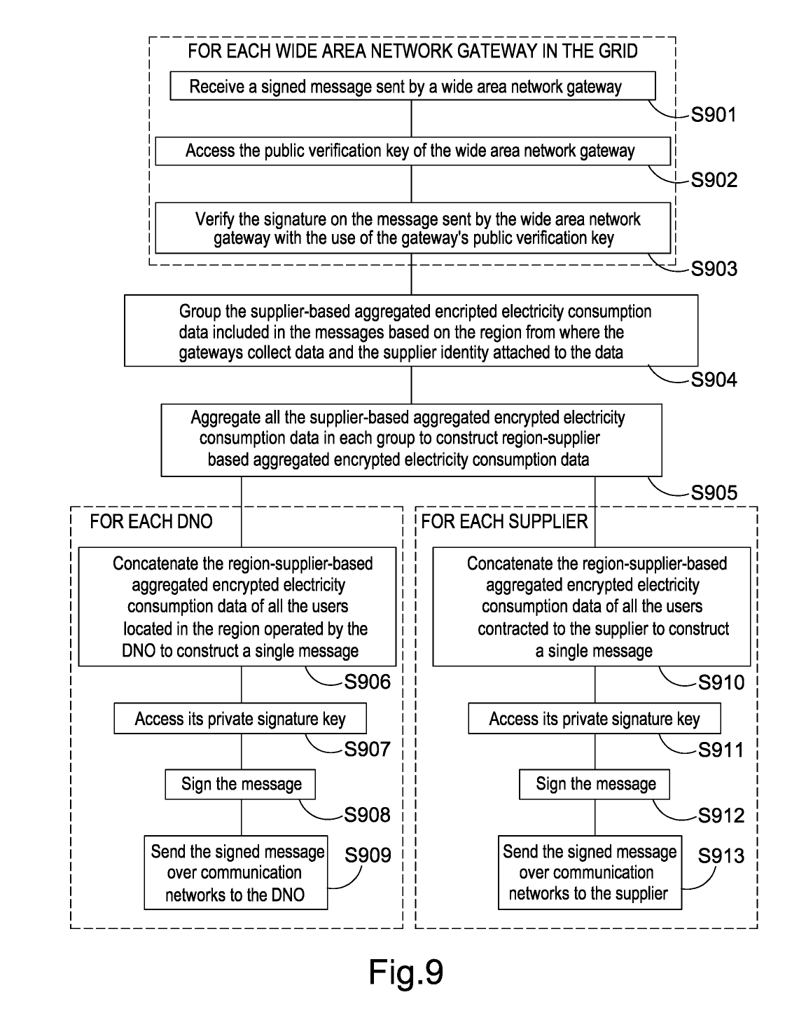

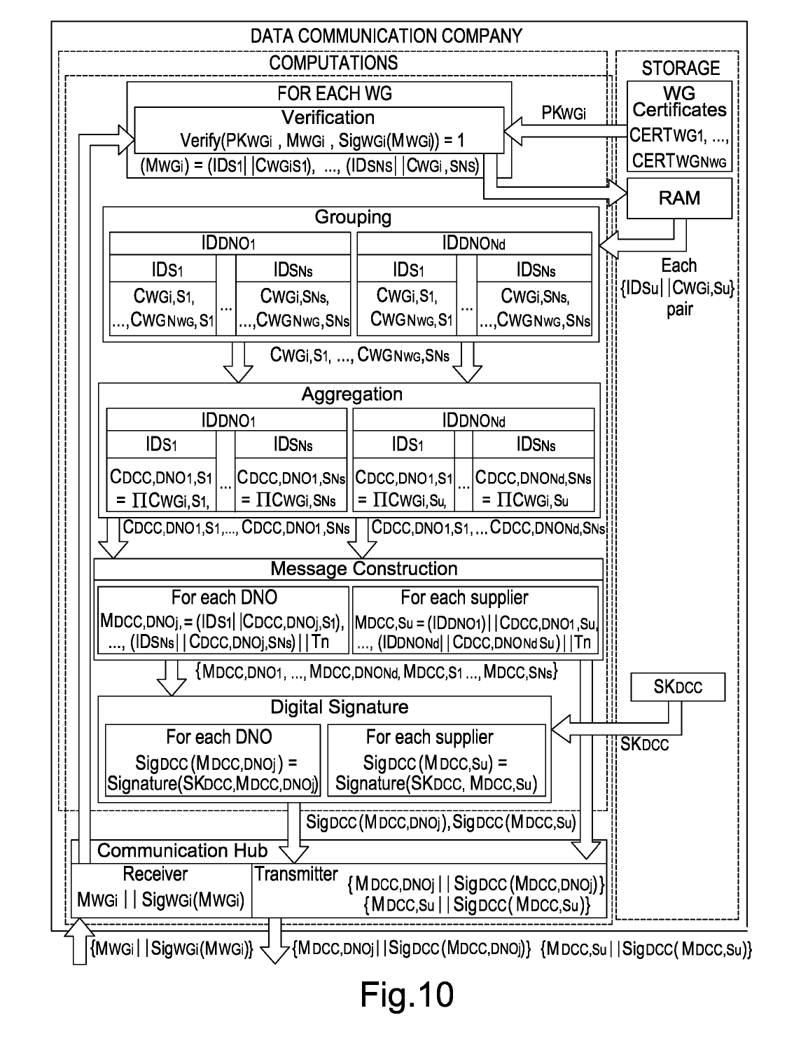

FIG. 9 shows a flow chart of the steps performed by the data communication company. FIG. 10 shows a schematic of the operations performed in the data communication company during the above process.

Referring to FIG. 9, the data communication company DCC receives the signed message sent by a wide area network gateway, e.g. WGi (step S901). The data communication company DCC accesses the public verification key of the wide area network gateway PK_{WGi} from the gateway's certificate CERT_{WGi} (step S902). The data communication company DCC verifies the signature on the message sent by the gateway with use of the gateway's public verification key PK_{WGi} (step S903). The data communication company DCC repeats the steps described above for each of the wide area network gateways in the grid.

In step S904, the data communication company DCC groups the supplier-based aggregated encrypted electricity consumption data included in the messages sent by the wide building area network gateways twice: firstly based on the regions from where those data come from (e.g. ID_{DNOj}) thus creating Nd number of groups (Nd is the number of the DNOs in the grid); and secondly based on the attached supplier identities (e.g. ID_{Su}) thus creating Ns (Ns is the number of suppliers in the grid) subgroups in each group. In other words, for each region (DNO) there are Ns groups resulting in total of {Nd×Ns} number of groups.

In step S905, the data communication company DCC aggregates all the supplier-based aggregated encrypted electricity consumption data in each group to form region-supplier-based aggregated encrypted consumption data that cover all the users in the grid. In other words, after the aggregation process there are {Nd×Ns} number of region-supplier-based aggregated encrypted consumption data.

For each distribution network operator DNOj, the data communication company DCC performs the following operations:
It concatenates the region-supplier-based aggregated encrypted electricity consumption data of the users located in the region operated by the distribution network operator to construct a single message M_{DCC,DNOj} (step S906).
It accesses its private signature key SK_{DCC} (step S907).
It generates a signature Sig_{DCC}(M_{DCC,DNOj}) on the message with the use of its private signature key SK_{DCC} (step S908).
It sends the signed message that contains the region-supplier-based aggregated encrypted consumption data over communication networks to the distribution network operator (step S909).

For each supplier, the data communication company DCC performs the following operations:
It concatenates the region-supplier-based aggregated encrypted electricity consumption data of the users contracted to the supplier to construct a single message M_{DCC,Su} (step S910).
It accesses its private signature key SK_{DCC} (step S911).
It generates a signature Sig_{DCC}(M_{DCC,Su}) on the message with the use of its private signature key SK_{DCC} (step S912).
It sends the signed message that contains the supplier-region-based aggregated encrypted consumption data over communication networks to the supplier (step S913).

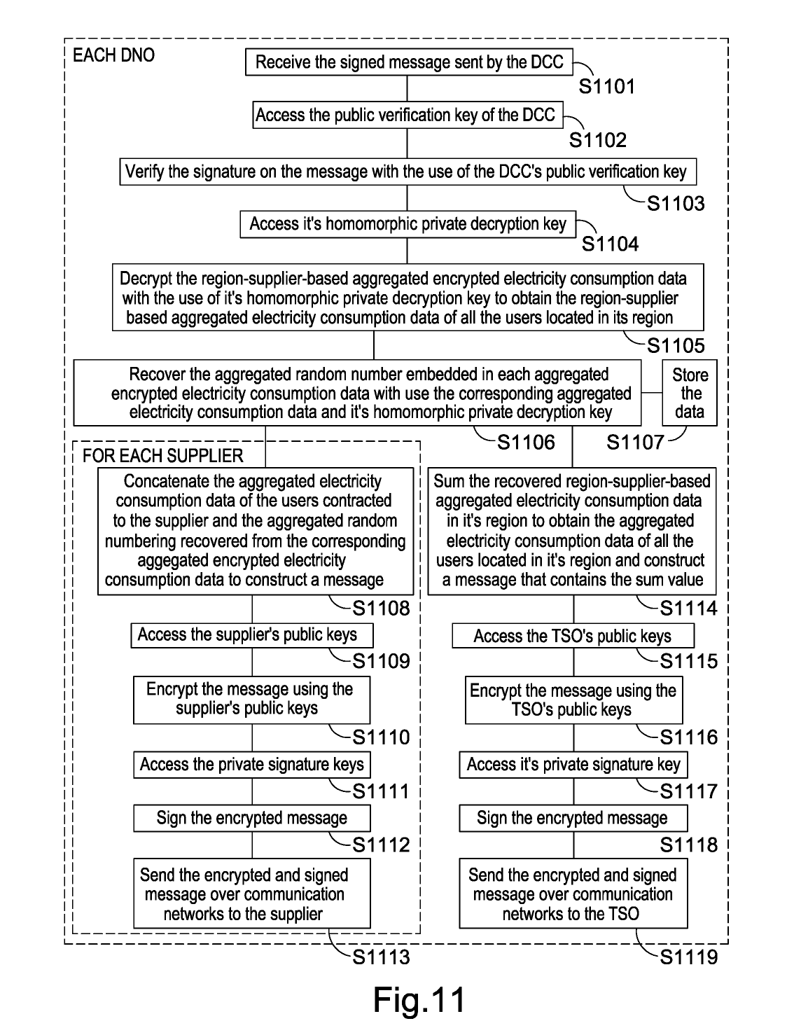

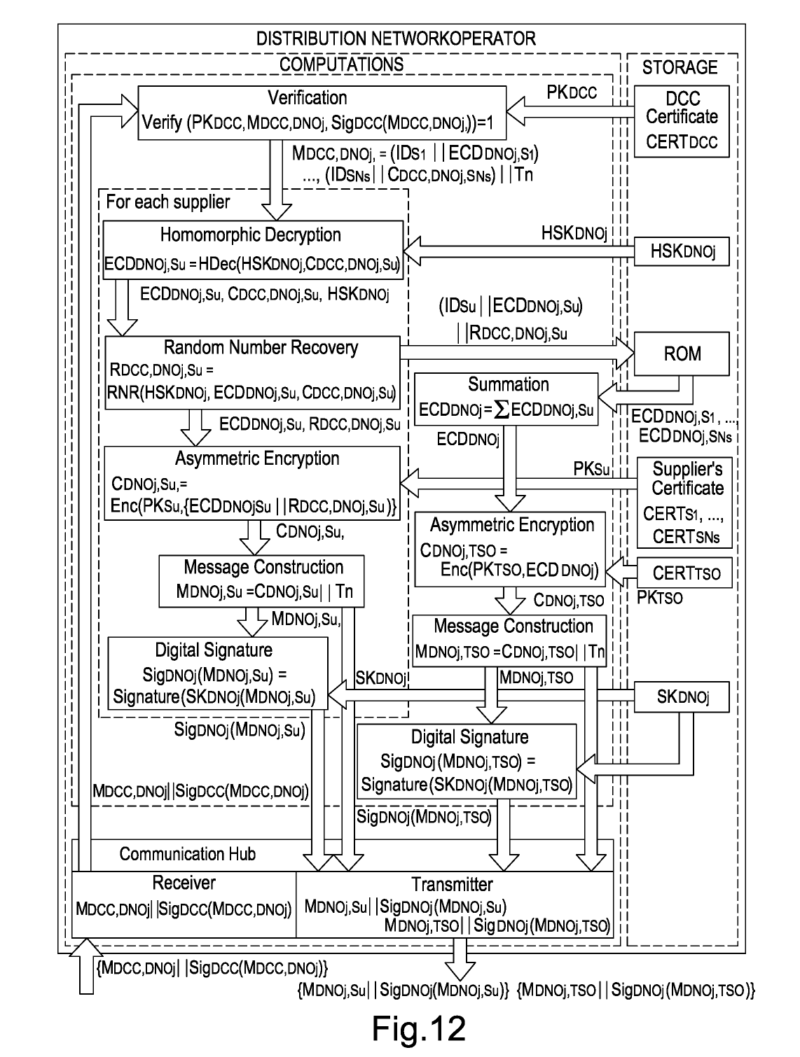

FIG. 11 shows a flow chart of the steps performed by the distribution network operator whilst FIG. 12 shows a schematic of the operations performed in the distribution network operator.

Referring to FIG. 11, a distribution network operator, e.g. DNOj, receives the signed message sent by the data communication company DCC (step S1101). In step S1102, the distribution network operator accesses the public verification key of the data communication company PK_{DCC} from the company's certificate CERT_{DCC}.

In step S1103, the distribution network operator verifies the signature on the message sent by the data communication company DCC with use of the company's public verification key PK_{DCC}. In step S1104, the distribution network operator accesses its homomorphic private decryption key HSK_{DNOj}. The distribution network operator decrypts the region-supplier-based aggregated encrypted consumption data, i.e. C_{DCC,DNOj,S}_{₁}, . . . , C_{DCC,DNOj,S}_{_{Ns}}, included in the message sent by the data communication company DCC with the use of its homomorphic private decryption key HSK_{DNO}_{ⱼ} to obtain the region-supplier-based aggregated electricity consumption data of all the users located in its region of operation, i.e. ECD_{DNOj,S}_{₁}, . . . , ECD_{DNOj,S}_{_{Ns}} (step S1105).

The distribution network operator recovers the aggregated random numbers, i.e. R_{DCC,DNOj,S}_{₁}, . . . , R_{DCC,DNOj,S}_{_{Ns}}, embedded in each of the aggregated encrypted consumption data, i.e. C_{DCC,DNOj,S}_{₁}, . . . , C_{DCC,DNOj,S}_{_{Ns}}, with the use of the corresponding aggregated consumption data, i.e. ECD_{DNOj,S}_{₁}, . . . , ECD_{DNOj,S}_{_{Ns}}, and its homomorphic private decryption key HSK_{DNOj} (step S1106). In step S1107, the distribution network operator stores the region-supplier-based aggregated consumption data and the recovered aggregated random numbers embedded in the aggregated encrypted data.

In step S1108, the distribution network operator sums the recovered region-supplier-based aggregated consumption data in its region to obtain the aggregated consumption data of all the users located in its region (regardless of the users' contracted supplier), i.e. ECD_{DNOj}, and constructs a message that contains the sum value.

The distribution network operator next accesses the public encryption key of the transmission system operator PK_{TSO} from the TSO's certificate CERT_{TSO} (step S1109). In step S1110, the distribution network operator encrypts the message containing the sum of the region-supplier-based aggregated consumption data with the use of the public encryption key of the transmission system operator PK_{TSO} to form an encrypted message M_{DNOj,TSO}.

In step S1111, the distribution network operator accesses its private signature key SK_{DNOj} and in step S1112, the distribution network operator generates a signature Sig_{DNOj}(M_{DNOj,TSO}) on the message with the use of its private signature key SK_{SNOj}. In step S1113, the distribution network operator sends the signed message that contains the encrypted region-based aggregated consumption data over communication networks to the transmission system operator TSO.

For each supplier, e.g. Su, the distribution network operator performs the following operations:
It concatenates the aggregated consumption data of the users contracted to the supplier and the aggregated random number recovered from the corresponding aggregated encrypted consumption data, i.e. {ECD_{DNOj,Su}∥R_{DCC,DNOj,Su}}, to construct a single message M_{DNOj,Su} (step S1114).
It accesses the public encryption key of the supplier PK_{Su} from the supplier's certificate CERT_{Su} (step S1115).
It encrypts the message containing the aggregated consumption data of the users contracted to the supplier and the aggregated random number with the use of the public encryption key of the supplier PK_{Su} (step S1116).
It accesses its private signature key SK_{DNOj} (step S1117).
It generates a signature Sig_{DNOj}(M_{DNOj,Su}) on the message with the use of its private signature key SK_{DNOj} (step S1118).
It sends the signed message that contains the encrypted aggregated consumption data of users contracted to the supplier and aggregated random number over communication networks to the supplier (step S1119).

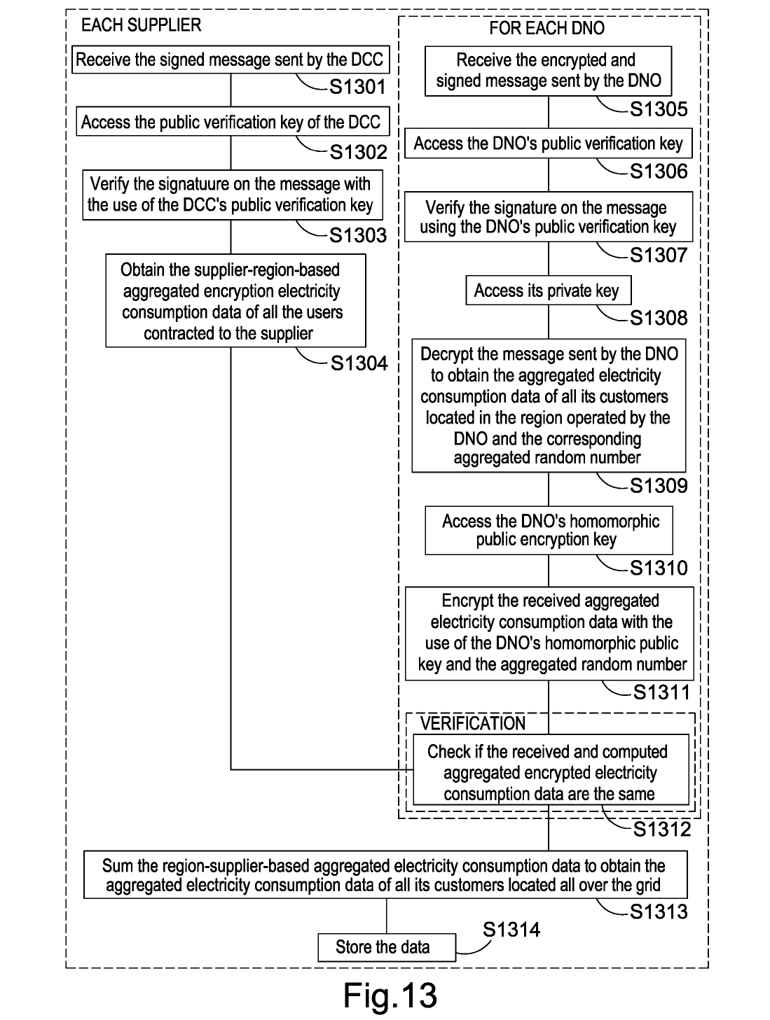

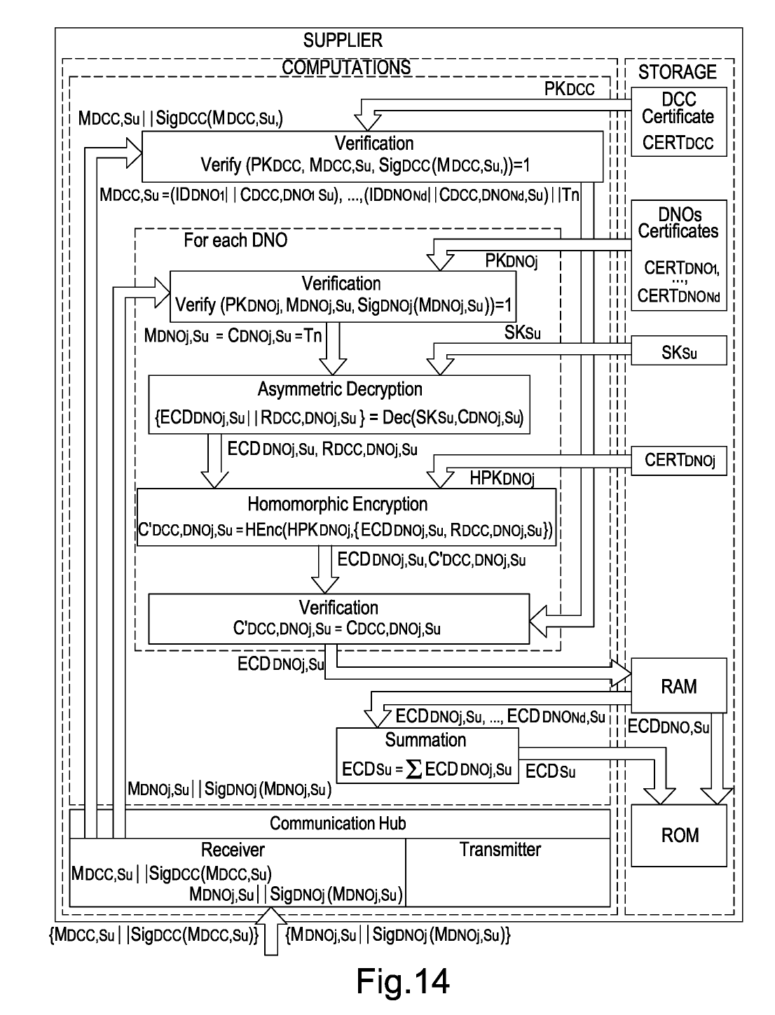

FIG. 13 shows a flow chart of the steps performed by a supplier. FIG. 14 shows a schematic of the operations performed by the supplier.

Referring to FIG. 13, a supplier, e.g. Su, receives the signed message sent by the data communication company DCC (step S1301). In step S1302, the supplier accesses the public verification key of the data communication company PK_{DCC} from the certificate of the company CERT_{DCC}. The supplier then verifies the signature on the message with use of the public verification key of the data communication company PK_{DCC} (step S1303). The supplier obtains the supplier-region-based aggregated encrypted consumption data of its customers located in different regions, i.e. C_{DCC,DNO1,Su}, . . . , C_{DCC,DNONd,Su} (step S1304).

For each distribution network operator, e.g. DNOj, the supplier performs the following operations:
It receives the encrypted and signed message sent by the distribution network operator DNOj (step S1305).
It accesses the public verification key of the distribution network operator PK_{DNOj} from the certificate of the operator CERT_{DNOj} (step S1306).
It verifies the signature on the message with the use of the distribution network operator's public verification key PK_{DNOj} (step S1307).
It accesses its private decryption key SK_{Su} (step S1308).
It decrypts the message sent by the distribution network operator with the use of its private decryption key SK_{Su} to obtain the aggregated electricity consumption data of its customers located in the region operated by the distribution network operator and the corresponding aggregated random number, i.e. {ECD_{DNOj,Su}∥R_{DCC,DNOj,Su}} (step S1309).
It accesses the distribution network operator's homomorphic public encryption key HPK_{DNOj} (step S1310).
It encrypts the recovered aggregated electricity consumption data ECD_{DNOj,Su} with the use of the distribution network operator's homomorphic public encryption key HPK_{DNOj} and the aggregated random number R_{DCC,DNOj,Su} (step S1311).
It verifies the correctness of the aggregated electricity consumption data received from the DNOj, i.e. ECID_{DNOj,Su}, by checking if the received from the DCC and the computed aggregated encrypted electricity consumption data are the same (step S1312).

Next, in step S1313, the supplier sums the region-supplier-based aggregated electricity consumption data sent by the distribution network operators, i.e. {ECD_{SNO1,Su}, . . . , ECD_{DNONd,Su}}, to obtain the aggregated electricity consumption data of all its customers (regardless the region where the customers are located), i.e. ECD_{Su}.

In step S1314, the supplier-region-based aggregated electricity consumption data {ECD_{DNO1,Su}, . . . , ECD_{DNONd,Su}} and the sum of these data ECD_{Su} are stored by the supplier.

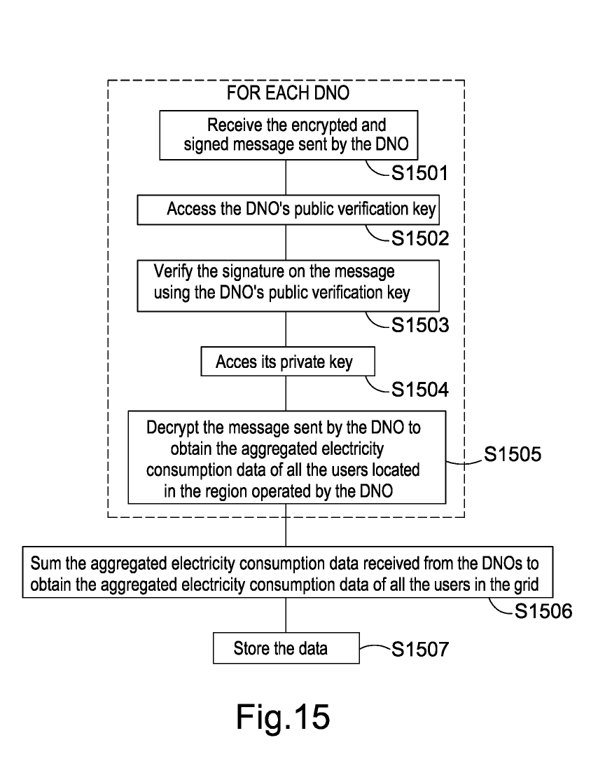

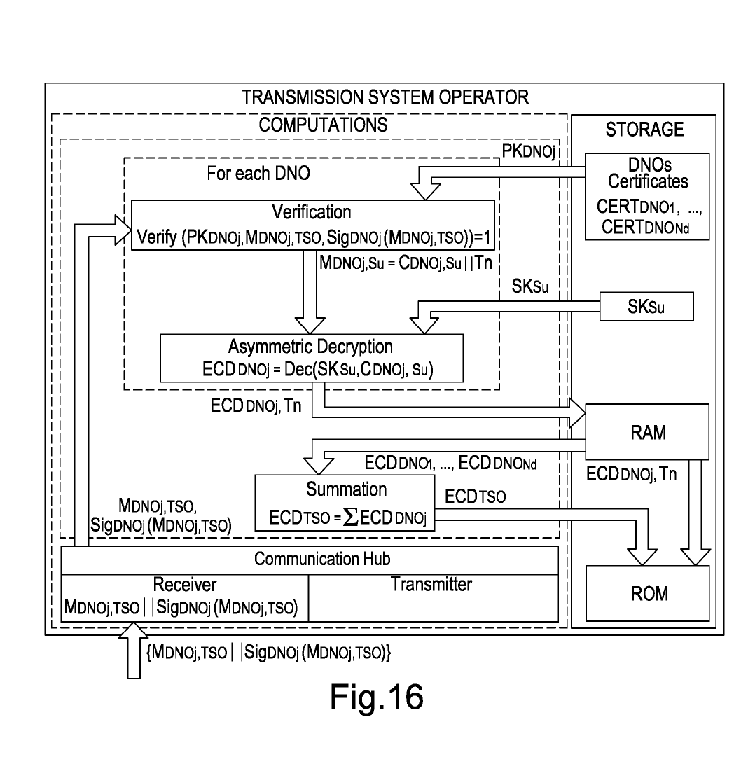

FIG. 15 shows a flow chart of the steps performed by the transmission network operator TSO. FIG. 16 shows a schematic of the operations performed by the TSO.

Referring to FIG. 15, for each distribution network operator, e.g. DNOj, the transmission system operator TSO performs the following operations:
It receives the encrypted and signed message sent by the distribution network operator DNOj (step S1501).
It accesses the public verification key of the distribution network operator PK_{DNOj} from the operator's certificate CERT_{DNOj} (step S1502).
It verifies the signature on the message with the use of the distribution network operator's public verification key PK_{DNOj} (step S1503).
It accesses its private decryption key SK_{TSO} (step S1504).
It decrypts the message sent by the distribution network operator with the use of its private decryption key SK_{TSO} to obtain the aggregated electricity consumption data of all the users located in the region operated by the distribution network operator ECID_{DNOj} (step S1505).

In step S1506, the transmission network operator TSO sums the aggregated consumption data sent by the distribution network operators, i.e. {ECD_{DNO1}, . . . , ECD_{DNONd}}, to obtain the aggregated consumption data of all of the users in the grid, ECD_{TSO}. In step S1507, the region-based aggregated electricity consumption data {ECD_{DNO1}, . . . , ECD_{DNONd}} and the sum of these data ECD_{TSO} are stored by the TSO.

In summary, each supplier, each distribution network operator and the transmission system operator receive only the high-frequency aggregated metering data of their respective users. These aggregated metering data should be sufficient for operational purposes such as demand management, grid balancing/management, distribution networks usage fee calculation, etc. Since none of these entities obtains the high-frequency metering data of an individual user, the user's privacy is protected. Moreover, the communication overheads in the advanced metering infrastructure are significantly reduced because of the selective aggregation and ciphertext-based data verification methods used.

A further embodiment of a smart meter is now described that will ensure a user's privacy is protected by preventing a supplier from accessing new attributable metering data at high frequency intervals, whilst still allowing a supplier to access attributable metering data at a minimum frequency required by the supplier (e.g. every month).

In the present embodiment, the smart meter is designed during the manufacturing process to compulsorily update its accounting register REG.ACC at this frequency (once a month). This can be done by setting the accounting register update rate REG.ACC UR to one month. Once a new smart meter has been installed and its accounting register REG.ACC has been updated with the initial meter readings, the contracted supplier will be assured that it can have access to new attributable meter readings at least ‘once a month’ as the execution of the attributable metering data reporting does not involve a user. The data updated ‘once a month’ should be sufficient for accounting purposes.

It is possible that some users will wish to provide their contracted suppliers with new attributable metering data more frequently. This could be done by requesting a higher accounting register update rate REG.ACC UR, thus allowing the supplier to pull new attributable metering data from the REG.ACC more frequently.

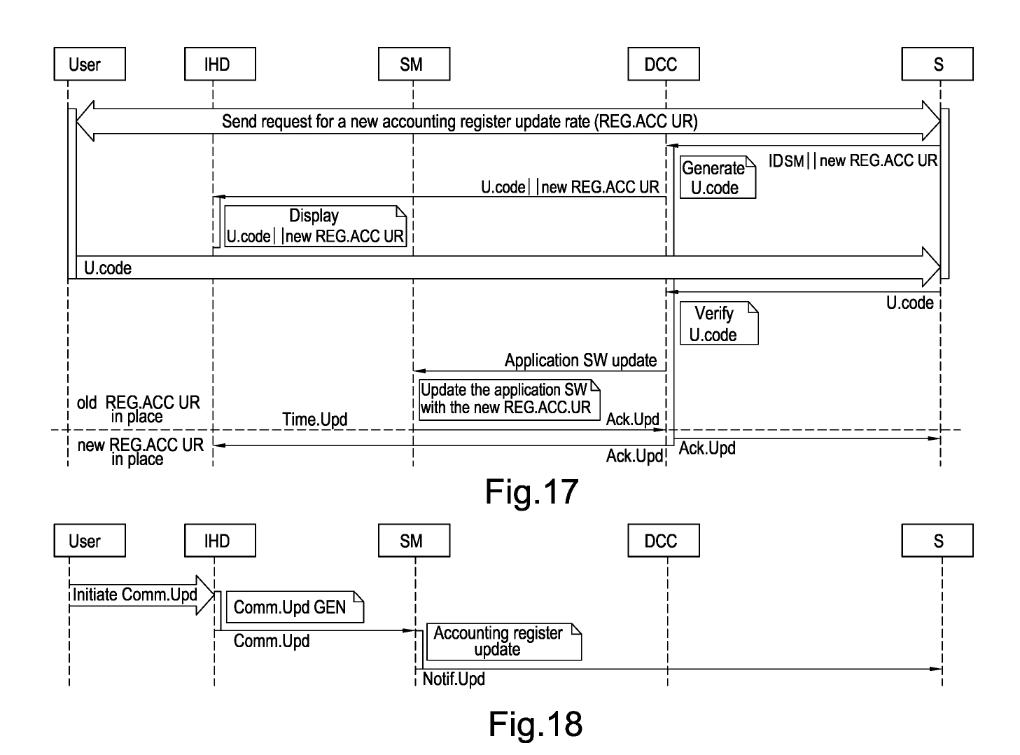

FIG. 17 depicts the operations and messages during an accounting register update rate REG.ACC UR change according to the present embodiment.

A user and his/her contracted supplier S establish a secure communication channel (e.g. via the Internet using standard security protocols or via phone). The initiator of the channel could be any of the parties.

The user sends the supplier S a request for a new accounting register update rate REG.ACC UR via the established communication channel.

All the messages from now on are sent via the advanced metering infrastructure. They are encrypted with the use of the intended recipient's public encryption key and signed with the use of the message originator's private signature key.

The supplier S sends a message to the data communication company DCC. The message contains the user smart meter's ID ID_{SM} and the new accounting register update rate, new REG.ACC UR, requested by the user.

The data communication company DCC receives the message sent by the supplier S and generates a unique user code U.code.

The data communication company DCC sends a message to the in-home display device IHD of the user (via the user's smart meter). The message contains the user code U.code and the new accounting register update rate, new REG.ACC UR.

The in-home display device of the user IHD receives the message sent by the data communication company DCC and displays the information contained in the message.

The user checks if the information displayed on the in-home display device IHD is correct, and sends the user code U.code to the supplier S via a new or already established secure communication channel.

The supplier S receives the message sent by the user, obtains the user code U.code and forwards the code to the data communication company DCC.

The data communication company DCC receives the user code U.code sent by the supplier S and verifies the code by comparing it to the original user code sent to the user by the data communication company DCC.

The data communication company DCC sends an update to the application software of the user's smart meter. The upgrade contains the new accounting register update rate, new REG.ACC UR.

The smart meter updates its software application with the new accounting register update rate, new REG.ACC UR. It, then, sends an acknowledgement of the update Ack.Upd to the data communication company DCC.

The data communication company DCC forwards to the supplier S and to the in-home display of the user IHD the acknowledgement of the update Ack.Upd. As the supplier S is aware of the user's accounting register update rate REG.ACC UR (i.e. the REG.ACC update schedule), the smart meter does not have to send any notifications to the supplier S when a scheduled REG.ACC update occurs.

Occasionally (when a tariff/account holder change occurs) a supplier S has to access new attributable metering data on demand (i.e. at out-of-schedule times) and such access should be always approved by the user. Therefore, such one-time REG.ACC update can be initiated by the user by using his/her in-home display device IHD. Also when such updates occur, the supplier S should be notified of the out-of-schedule REG.ACC update. Note that such updates will not affect the beforehand set regular REG.ACC update schedule.

FIG. 18 depicts the operations and messages sent during a one-time REG.ACC update. A user initiates the one-time REG.ACC update by choosing the corresponding option on the menu of the in-home display device IHD located in her/his house. This option may be also username/password protected. The in-home display device IHD generates a one-time REG.ACC update command Comm.Upd, encrypts and integrity protects it (with the symmetric key K_{IHD}) before sending it to the smart meter. The smart meter receives and verifies the update command Comm.Upd. Then, it updates its accounting register and sends an encrypted and signed notification of the one-time REG.ACC update to the supplier S.

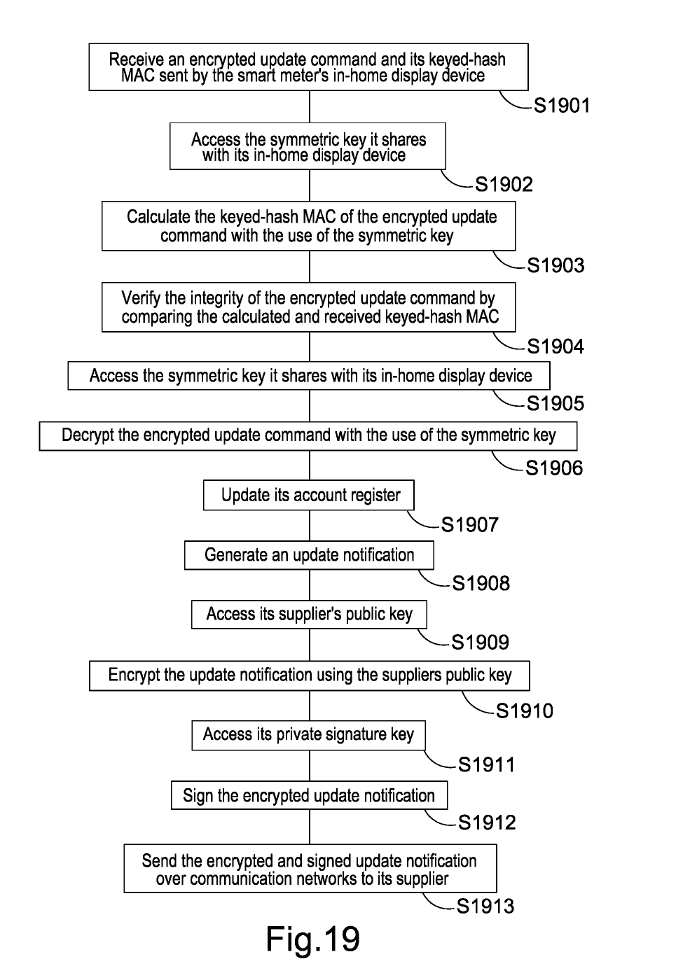

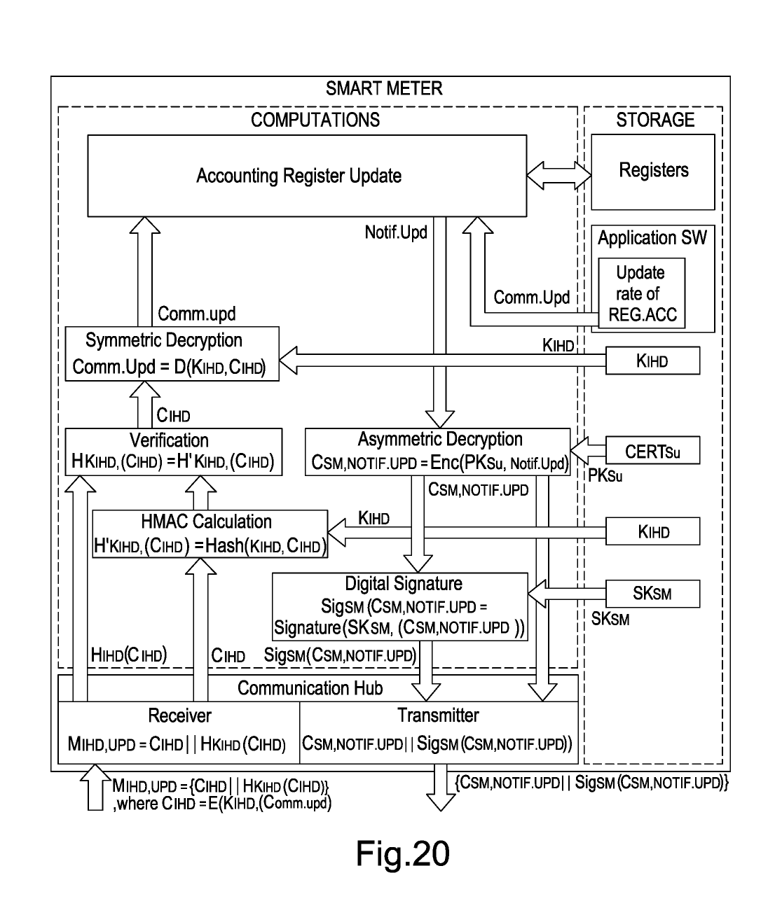

A flow and schematic diagram of the operations performed by the smart meter during the one-time REG.ACC update are shown in FIG. 19 and FIG. 20, respectively.

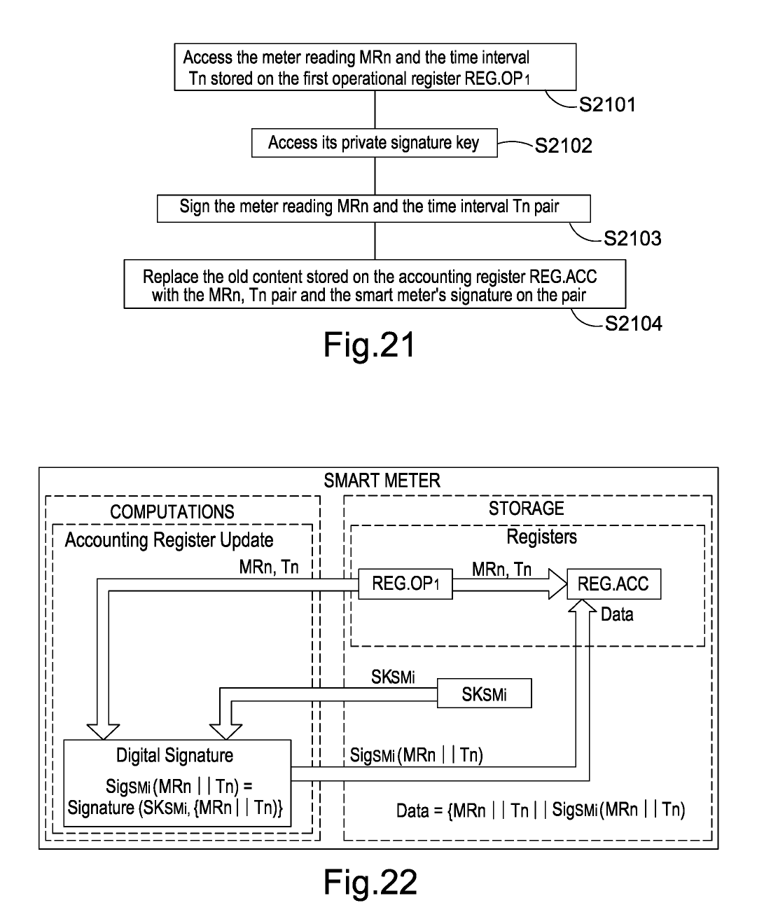

A flow and schematic diagram of the operations performed by the smart during the actual accounting register update are shown in FIG. 21 and FIG. 22, respectively. In summary, this arrangement of the smart meter's registers and the REG.AGG update rate set by design guaranties that:
The supplier can have access to its user's attributable metering data once a month independently of the user;
The user's privacy is protected as the supplier cannot access the user's attributable metering data less frequently than once a month.

However, the arrangement also allows each user to choose the update rate of the accounting register, thus managing his/her own privacy.

It also allows the user to make one-time (on demand) updates of the accounting register and inform the supplier about such updates.

FIG. 19 depicts a flow diagram of the operations performed by a smart meter during an accounting register update initiated by the smart meter user. In step S1901, a smart meter receives an encrypted update command and the keyed-hash message authentication code of the encrypted command, i.e. {C_{IHD}∥H_{KIHD}(C_{IHD})}, sent by a user using the in-home display device IHD located inside the user's house. In step S1902, the smart meter accesses the symmetric key KIHD which it shares with the in-home display device IHD.

In step S1903, the smart meter calculates the keyed-hash message authentication code of the encrypted command with the use of the symmetric key K_{IHD}. In step S1904, the smart meter verifies the integrity of the encrypted command by comparing the received and calculated keyed-hash message authentication codes. The smart meter accesses the symmetric key K_{IHD} (step S1905) and decrypts the encrypted command with the use of the symmetric key K_{IHD} (step S1906). In step S1907, the smart meter upgrades its accounting register (further details of the steps involved in the update are shown in FIG. 21 and FIG. 22).

In step S1908, the smart meter generates a notification for the update. In step S1909, the smart meter accesses the public encryption key of its user's contracted supplier PKs. In step S1910, the smart meter encrypts the notification for the update with the use of the public encryption key of the supplier PKs. The smart meter next accesses its private signature key SK_{SM} (step S1912) and signs the encrypted notification. The smart meter then sends the encrypted and signed notification over communication networks to the supplier (step S1913).

FIG. 20 depicts a schematic diagram of operations performed by a smart meter during the accounting register update initiated by the smart meter user or by the smart meter application software.

The accounting register update unit takes as input the update command Comm.Upd from the decryption unit of the smart meter or from the application software unit where the update rate of the accounting register is embedded, and performs the update. If the command Comm.Upd comes from the symmetric decryption unit, it means that the update has been initiated by the user (it is not a scheduled update) and the user's supplier S should be informed for the update. Therefore, the smart meter generates an update notification Notif.Upd, encrypts it with the supplier's public encryption key, signs it with its private signature key and sends the encrypted and signed notification to the supplier.

If the update command Comm.Upd comes from the application software unit, it means that the update is part of the scheduled update agreed between the user and the supplier S. So, the smart meter does not need to generate an update notification. FIG. 21 and FIG. 22 depict a flow and schematic diagrams, respectively, of the operations performed by the smart meter during the accounting register update. The smart meter accesses the meter reading MRn and the time interval Tn stored on the first operational register REG.OP₁ where the most recent data are stored. The digital signature unit of the meter takes as input the meter reading MRn and the time interval Tn and generates a signature on them Sig_{SM}(MRn, Tn) using the private signature key of the smart meter SKsm accessed from the storage.

The smart meter replaces the old content of the accounting register REG.ACC with the meter reading MRn, time interval Tn and the signature on both items Sig_{SM}(MRn, Tn). Thus the accounting register REG.ACC stores the following data: Data={MRn∥Tn∥Sig_{SMi}(MRn∥Tn)}.

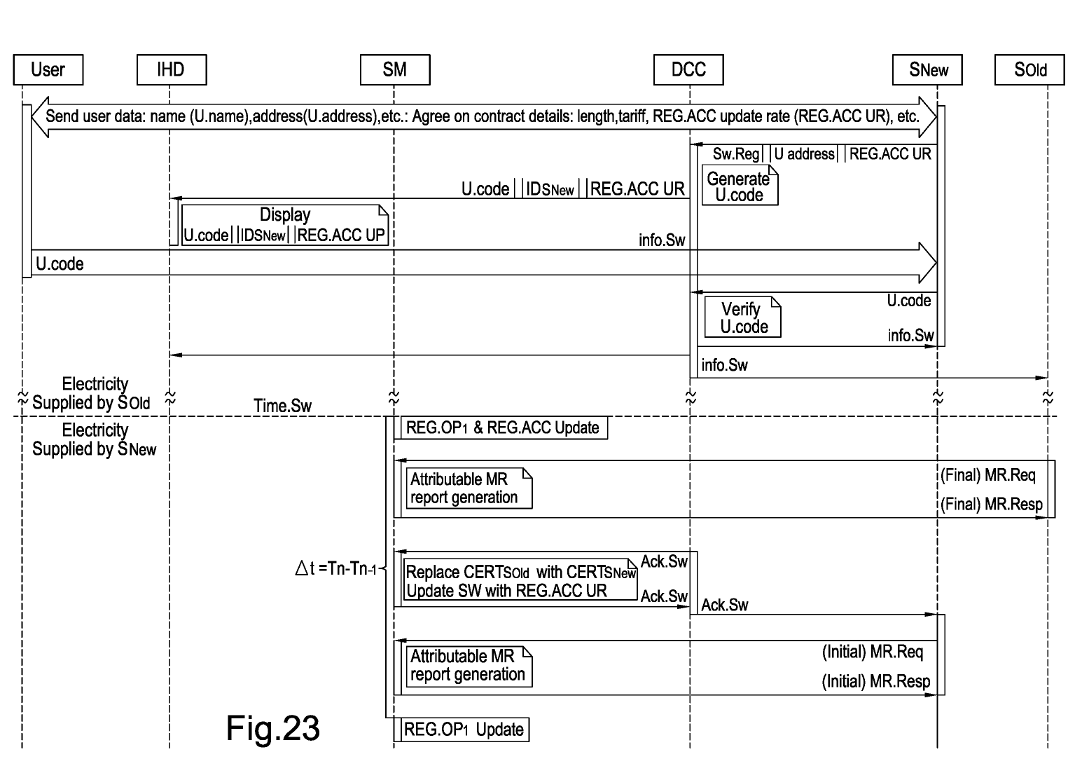

FIG. 23 depicts a flow diagram of the operations involved when a user chooses to switch utility supplier. A user establishes a secure communication channel (e.g. via the Internet using standard security protocols or via phone) with a supplier S_{N}to which the user wants to switch. The initiator of the channel could be any of the both parties. The user sends the new supplier S_{New} his/her personal data such as a name U.name, address U.address, etc. via the established secure communication channel. The user and the new supplier S_{New} also agree on a contract details such as contract length, tariff, accounting register update rate REG.ACC UR, etc.

All the messages from now on are sent via the advanced metering infrastructure. They are encrypted with use of the intended recipient's public encryption key and signed with the use of the originator's private signature key.

The new supplier S_{New} sends a message to the data communication company DCC. The message contains a supplier switch request Sw.Req, the user's address

U.address and the accounting register update rate REG.ACC UR which was agreed between the user and the new supplier S_{New}.

The data communication company DCC receives the message sent by the new supplier S_{New}, identifies the smart meter SM of the user based on the user's address and generates a unique user code U.code.

The data communication company DCC sends a message to the in-home display device IHD of the user (via the user's smart meter). The message contains the user code U.code, the identity of the new supplier ID_{SNew} and the accounting register update rate REG.ACC UR.

The in-home display device of the user IHD receives the message sent by the data communication company DCC and displays the information contained in the message. The user checks if the information displayed on the in-home display device IHD is correct, and sends the user code U.code to the new supplier S_{New} via a new or already established secure communication channel.

The new supplier S_{New} receives the message sent by the user, obtains the user code U.code and forwards the code to the data communication company DCC.

The data communication company DCC receives the user code U.code sent by the new supplier S_{N}and verifies the code by comparing it to the original user code sent to the user by the data communication company DCC.

The data communication company DCC sends the new supplier S_{New}, the old supplier S_{Old} and the in-home display of the user IHD information about the planned switch Info.Sw which contains data such as the exact date and time Time.Sw of the scheduled switch.

At the switch time Time.Sw, the smart meter of the user updates its operational and accounting registers. The old supplier S_{Old} sends a (final) attributable meter readings request MR.Req to the smart meter of the user.

The smart meter receives and verifies the request, performs an attributable meter reading report generation and sends the (final) attributable meter readings to the old supplier S_{Old}.

The data communication company sends the certificate of the new supplier CERT_{SNew} and an upgrade to the application software of the user's smart meter. The upgrade contains data such as the new accounting register update rate REG.ACC UR. The smart meter replaces the certificate of the old supplier with the certificate of the new supplier. It also updates the software application with the new accounting register update rate. It, then, sends an acknowledgement of the switch Ack.Sw to the data communication company DCC.

The data communication company DCC receives the acknowledgement of the switch and forwards it to the new supplier S_{New}.

The new supplier S_{New} sends an (Initial) attributable meter reading request to the smart meter.

The smart meter receives and verifies the request (as the smart meter stores the certificate of the new supplier), performs an attributable meter readings report generation and sends the (initial) meter readings (which are the same as the final meter readings obtained by the old supplier S_{Old}) to the new supplier S_{New}.

In summary, the switching process is easy and simplified as only the certificate of the current supplier stored on the user's smart meter needs to be replaced with the certificate of the new supplier. No change of cryptographic secret keys in the smart meter is required.

It will be seen that embodiments described herein provide a number of useful features, including:
The provision of high-frequency aggregated metering data reporting (e.g. every 15 minutes) to grid operators and suppliers. As such reporting provides grid operators and suppliers only with the aggregated consumption data of their respective users, users' privacy is protected.
Reduced computational cost at a smart meter: each smart meter needs to generate just one report at each time slot, but yet the electricity consumption data included in the report is delivered (in an aggregated form) to three different entities, i.e. the smart meter's regional DNO, the SM user's contracted supplier and the TSO;
Scalability
   an increase in the number of smart meters in the grid will increase linearly only the computational costs at BGs and the communicational overheads between the SMs and BGs, but it will not affect the other part of the grid;
   an increase in the number of suppliers in the grid will increase linearly 1) the communication overheads in the grid apart from the part between the SMs and BGs which will not be affected and 2) the computational costs at the DCC, each DNO and each supplier, but it will have a negligible effect on the gateways;
High-frequency metering data reporting (e.g. every 1 minute) to users. As such reporting is secured with the use of a secret symmetric key shared only between the smart meter and the corresponding in-home display device, users' privacy is protected;
a guaranteed ‘once in a while’ (e.g. once a month) access to new attributable metering data for the supplier by design; As the scheduled attributable metering data reporting does not involve a user, the supplier can access the attributable data independently from the user;
a protection of an user's new attributable metering data from being read by the supplier very frequently by design; an adjustment of a user's attributable metering data release to the supplier; i.e.
a degree of control that a smart meter user has over the frequency of her/his attributable metering data release to the supplier, thus controlling the privacy preservation level applicable to her/him;
user's attributable metering data release to the supplier on demand;
an easy supplier switching process; there is no need to replace a user's smart meter or any secret keys on the smart meter but only the certificate of the current supplier held on the smart meter with the certificate of the new supplier;

Additionally, this system creates a new product, i.e. a smart meter with embedded user privacy protection by design, which users may opt for with an additional charge.

Two envisaged scenarios using this invention are described here:
a) A supplier company could either offer a selection of smart meters for a consumer to choose from during installation, where inclusion of this invention is considered to be an advantage to the consumer. By doing so the supplier company could perhaps attract new customers by offering them a higher degree of privacy.

A customer could choose and arrange for installation of a particular brand of smart meter that incorporates the technology described in this document.

Thus, embodiments described herein can help to provide a secure and privacy-preserving delivery method of aggregated data to many (untrusting each other) recipients of the same data using a novel ciphertext-based data verification method with the help of a semi-trusted (i.e. honest-but-curious) third party. Embodiments also provide a smart metering system that can support a number of services for different smart grid parties, in a secure and privacy-balancing and supplier-adaptable manner that is summarised as follows:
Frequent aggregated metering data are reported to grid operators and suppliers; such aggregated data are required for demand side management purposes.

The reporting is based on the aforementioned novel delivery method. The reporting frequency of such data could be as high as every minute.
Frequent metering data are reported to a user; such data is required by a user for purposes such as consumption data awareness. The reporting frequency of such data could be as high as every second.
Attributable metering data are reported to a supplier company; such attributable data is required by a supplier for purposes such as billing and account management. To protect users' privacy, new attributable metering data release frequency to the supplier is set to a low value, e.g. every 1 month.
Attributable metering data release frequency adjustment; such adjustment allows a user to control his/her attributable metering data release frequency to the supplier in a range of a minimum frequency required by supplier (e.g. 1 month) and a maximum frequency that is technically possible.
Attributable metering data release to the supplier on-demand; such one-time data release to the supplier is required in events such as change of tariff/account holder.
Easy supplier switching process; a user-simplified supplier switching process is proposed to help users to switch providers more often, thus minimising their electricity costs

While certain embodiments have been described, these embodiments have been presented by way of example only, and are not intended to limit the scope of the invention. Indeed, it will be understood that although embodiments discussed above are concerned with measuring and distributing utility data, embodiments described herein are also applicable to other types of data including e.g. sensory data indicating properties of the environment such as temperature, humidity etc. Such data may be recorded by appropriate metering devices and encrypted and distributed to multiple recipients using the same methods described above in relation to utility data. The novel methods, devices and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the inventions.

1. A method for distributing data from one or more metering devices to two or more third parties, comprising:
recording units of data at the one or more metering devices;
encrypting each unit of data to form a respective encrypted message, the encryption being carried out using an encryption key associated with a first one of the third parties;
sending the encrypted messages to a message aggregator;
aggregating, at the message aggregator, the encrypted messages to form an encrypted sum of the units of data;
sending the encrypted sum of the units of data from the message aggregator to the first one of the third parties and to a second one of the third parties;
decrypting the encrypted sum received from the message aggregator at the first one of the third parties using the encryption key to thereby obtain the sum of the units of data at the first one of the third parties;
sending the decrypted sum of the units of data from the first one of the third parties to the second one of the third parties;
encrypting, at the second one of the third parties, the sum of the units of data received from the first one of the third parties, the encryption being carried out by using the encryption key; and
comparing, at the second one of the third parties, the result of encrypting the sum of the units of data received from the first one of the third parties with the encrypted sum received from the message aggregator, so as to verify the validity of the sum of the units of data received by the second one of the third parties from the first one of the third parties.

2. A method according to claim 1, wherein the metering devices are utility meters configured to record utility data indicating the extent of usage of a particular utility during one or more time intervals.

3. A method according to claim 2, wherein each unit of utility data comprises a measure of electricity consumed during a time interval.

4. A method according to claim 1, wherein said encryption key is a public homomorphic key that forms part of a homomorphic public/private key pair of the first one of the third parties, wherein the first one of the third parties uses the homomorphic private key to decrypt the sum of the units of the data.

5. A method according to claim 1, wherein when encrypting the units of data, the units of data are securely bound to a verification nonce in the form of a random number;
wherein on decrypting the sum of the units of data, the first one of the third parties recovers the verification nonce and sends the nonce to the second one of the third parties together with the decrypted sum of the units of data.

6. A method according to claim 3, wherein:
the first one of the third parties comprises a distribution network operator of an electrical power grid, the distribution network operator being configured to perform load management in a region of the power grid; and
the second one of the third parties comprises a utility service provider, the utility service provider being a company responsible for supplying electricity to the site(s) at which the utility meters are located.

7. A method according to claim 6, wherein the third parties include a plurality of different utility service providers; and
wherein when sending an encrypted message to the message aggregator, each utility meter also sends to the message aggregator an indication of the utility service provider that is responsible for supplying electricity to the site at which the utility meter is located.

8. A method according to claim 7, wherein the message aggregator generates a separate encrypted sum for each utility service provider, wherein the encrypted sum that is generated for a respective utility service provider comprises an encrypted sum of the units of utility data received from utility meters that are located at sites supplied by that utility service provider.

9. A method according to claim 8, wherein the message aggregator sends each one of the encrypted sums to the distribution network operator and further sends each one of the encrypted sums to the respective utility service provider;
the distribution network operator decrypts each one of the encrypted sums received from the message aggregator and sends each decrypted sum to the respective utility service provider; and
each one of the utility service providers compares the sum of the units of utility data received from the distribution network operator with the encrypted sum received from the message aggregator, so as to verify the validity of the sum of the units of utility data received from the distribution network operator.

10. A method according to any one of claims 7 to 9, wherein the third parties include a plurality of different distribution network operators and utility service providers, each distribution network operator being configured to perform load management in a respective region of the power grid, each distribution network operator having its own homomorphic public/private key pair;
wherein each utility meter carries out encryption of its utility data using the homomorphic public key belonging to the distribution network operator that is responsible for load management in the region of the grid in which the respective utility meter is located, and sends to the message aggregator an indication of that distribution network operator;
wherein, for each one of the distribution network operators, the message aggregator generates a respective set of encrypted sums that is encrypted with the homomorphic public key of the respective distribution network operator; wherein within each set, each one of the encrypted sums comprises an encrypted sum of the units of utility data received from utility meters that are located at sites supplied by a respective one of the utility service providers.

11. A method according to claim 10, wherein the message aggregator sends each set of encrypted sums to its respective distribution network operator and sends to each utility service provider each one of the encrypted sums that is an encrypted sum of units of utility data received from utility meters that are located at sites supplied by that respective utility service provider.

12. A method according to claim 11, wherein each distribution network operator decrypts each one of the encrypted sums received from the message aggregator and sends each decrypted sum to the respective utility service provider; and for each decrypted sum that a utility service provider receives from a respective distribution network operator, the utility service provider encrypts the sum with the homomorphic public key of the respective distribution network operator and compares the result with the encrypted sum received from the message aggregator, so as to verify the validity of the sum of the units of utility data received from the distribution network operator.

13. A method according to any one of the preceding claims, wherein in sending the encrypted messages from the metering devices to the message aggregator, the encrypted messages are further encrypted using an encryption key shared between the metering devices and the message aggregator.

14. A method for validating data received by a first party from a second party, the data comprising an aggregate sum of units of data recorded by one or more metering devices, the method comprising:
receiving, at the first party, the aggregate sum of units of data from the second party;
receiving, at the first party, an encrypted aggregate sum of the units of data from a message aggregator to which each metering device has reported its readings, the aggregate sum being encrypted using an encryption key associated with the second party;
encrypting the sum of the units of the data received from the second party using the encryption key; and
comparing, at the first party, the result of encrypting the sum of the units of data received from the second party with the encrypted aggregate sum received from the message aggregator, so as to verify the validity of the aggregate sum of the units of data received from the second party.

15. A method according to claim 14, wherein:
the first party is a utility service provider;
the second party is a distribution network operator of a utility supply infrastructure, the distribution network operator being configured to manage distribution of the utility across a geographic region; and
the units of data comprise utility data recorded by one or more utility meters located in said region, each unit of utility data indicating the extent of use of a utility during a time interval.

16. A method for reporting utility consumption at one or more sites, the method comprising:
receiving, at a message aggregator, an encrypted message from each one of a plurality of utility meters, each message encrypting a unit of utility data that indicates the extent of use of a utility during a time interval;
receiving from each one of the plurality of utility meters, an indication of a distribution network operator that is responsible for managing distribution of the utility across a geographic region in which the utility meter is located;
receiving from each one of the plurality of utility meters, an indication of a utility service provider that is responsible for supplying the utility to the site in which the utility meter is located;
for each one of the distribution network operators:
generating a respective set of encrypted sums, wherein within each set, each encrypted sum comprises an encrypted sum of the units of utility data received from utility meters that are located at sites supplied by a respective one of the utility service providers, the encryption being carried out using an encryption key associated with the respective distribution network operator; and
sending each set of encrypted sums to the respective distribution network operator; and
sending to each utility service provider each one of the encrypted sums that is an encrypted sum of units of utility data received from utility meters that are located at sites supplied by that respective utility service provider.

17. A method according to claim 15 or 16, wherein the utility is electricity and the distribution network operator is configured to perform load management in a respective region of an electrical power grid.

18. A method according to any one of the preceding claims, wherein the steps of the method are repeated for each one of a plurality of time intervals.

19. A method according to claim 18, wherein each time interval is 30 minutes or less in duration.

20. A utility meter for monitoring usage of a utility at a site, comprising an account register for logging readings of utility usage;
the utility meter being configured to write new readings to the account register at predetermined intervals;
wherein the utility meter is configurable to alter the interval at which new readings are written to the account register;
the utility meter being configured to reply with the readings from its account register to any request sent by the user's supplier company;
wherein the utility meter is configurable to write new readings to the account register and send notification to the supplier company at a command sent by the user.
